(19) United States
(12) Patent Application Publication
(10) Pub. No.: US 2024/0246134 A1
(43) Pub. Date: Jul. 25, 2024

(54) STRUCTURAL MEMBER DESIGN METHOD, STEEL SHEET MANUFACTURING METHOD, TAILORED BLANK MANUFACTURING METHOD, STRUCTURAL MEMBER MANUFACTURING METHOD, AND STRUCTURAL MEMBER

(71) Applicant: NIPPON STEEL CORPORATION, Tokyo (JP)

(72) Inventors: Koichi HAMADA, Tokyo (JP); Toshiya SUZUKI, Tokyo (JP); Yujiro TATSUMI, Tokyo (JP); Naruhiko NOMURA, Tokyo (JP)

(73) Assignee: NIPPON STEEL CORPORATION, Tokyo (JP)

(21) Appl. No.: 18/564,421

(22) PCT Filed: Aug. 3, 2022
(86) PCT No.: PCT/JP2022/029797

§ 371 Date: Nov. 27, 2023

(30) Foreign Application Priority Data
Aug. 3, 2021 (JP) 2021-127370

(51) Int. Cl. B21D 22/26; B23K 26/322; B23K 101/18; B23K 103/04; B23K 103/10

(52) U.S. Cl. CPC B21D 22/26; B23K 26/322; B23K 2101/185; B23K 2103/04; B23K 2103/10

(57) ABSTRACT

This structural member design method is a method for designing a structural member obtained by forming a tailored blank. The method includes: a weld setting step of performing crash analysis by numerical simulation on an analytical model of the structural member, and setting the position of the weld such that a fracture index of a first region is equal to or more than a specified value and the fracture indices of all remaining regions other than the first region are less than the specified value; and a removal region setting step of setting, after the weld setting step, a region including a portion corresponding to the first region in the joined end portion as a removal region where the exposed portion is formed.

### TECHNICAL FIELD OF THE INVENTION

The present invention relates to a structural member design method, a steel sheet manufacturing method, a tailored blank manufacturing method, a structural member manufacturing method, and a structural member.

The present application claims priority based on Japanese Patent Application No. 2021-127370 filed in Japan on Aug. 3, 2021, the contents of which are incorporated herein by reference.

### RELATED ART

In recent years, in order to protect the global environment by reducing CO₂ gas emissions, weight reduction of an automobile body is an urgent issue in an automobile field. In order to solve this issue, studies to apply a high strength steel sheet have been actively performed. The strength of a steel sheet (plated steel sheet) is increasing more and more.

Hot press (hereinafter, also referred to as “hot stamping”) has attracted attention as one of technologies of forming an automobile member. In the hot stamping, a steel sheet is heated to a high temperature and press-formed in a temperature range equal to or higher than an Ar₃ transformation temperature. Furthermore, in the hot stamping, a press-formed steel sheet is rapidly cooled by heat removal with a die, and transformation is caused simultaneously with forming in a state where a press pressure is applied. The hot stamping is a technology capable of manufacturing a hot press-formed article (hereinafter, also referred to as a “hot stamped product”) having high strength and excellent shape fixability through the above step.

In addition, in order to improve a yield and functionality of a press-formed article of an automobile member, a tailored blank in which end surfaces of at least two steel sheets are butted and joined by laser welding, plasma welding, or the like is applied as a press material. In the tailored blank, since a plurality of steel sheets is joined according to a purpose, a sheet thickness and strength can be freely changed in one part. As a result, by using the tailored blank, the functionality of the automobile member can be improved, and the number of parts of the automobile member can be reduced. In addition, by hot-stamping the tailored blank, it is possible to manufacture a high strength press-formed article in which a sheet thickness, strength, and the like are freely changed.

When the tailored blank is used as a press material and an automotive member is formed by hot stamping, the tailored blank is heated to, for example, a temperature range of 800° ° C. to 1000° ° C. For this reason, as the tailored blank for hot stamping, an aluminum-plated steel sheet such as Al—Si having a plating boiling point higher than that of Zn-based plating is often used.

When the aluminum-plated steel sheets are butt-welded, a concentration of aluminum of a weld increases, and hardenability decreases. As a result, there is a problem that the strength of the weld decreases.

In order to solve this problem, there is a technology of removing aluminum plating in a region where the aluminum-plated steel sheets are butt-welded.

Patent Document 1 discloses a method in which one or more of sheet metal pieces contain a coating material layer and a weld notch, and at least a part of the coating material layer is removed from an edge region before welding such that a weld joint portion contains substantially no substance constituting the coating material layer.

Patent Document 2 discloses a technology in which a sheet is constituted by a steel substrate and a precoating, the precoating is constituted by an intermetallic alloy layer which is in contact with the substrate and on which a metal alloy layer is placed, one zone does not include the metal alloy layer on at least one precoated surface of the sheet, and the zone is located around the sheet.

### CITATION LIST

### Patent Document

### Patent Document 1

Japanese Patent No. 6034490

### Patent Document 2

Japanese Patent No. 5237263

### SUMMARY OF INVENTION

### Problems to be Solved by the Invention

In the technologies described in Patent Documents 1 and 2, since aluminum plating in an entire region to be welded is removed, there is a problem that it takes time to remove the aluminum plating.

The present invention has been made in view of the above problem, and an object of the present invention is to provide a structural member design method, a steel sheet manufacturing method, a tailored blank manufacturing method, a structural member manufacturing method, and a structural member, capable of suppressing fracture of the structural member, shortening time for removing aluminum plating, and prolonging a life of a tool.

### Means for Solving the Problem

In order to solve the above problem, the present invention adopts the following means.

(1) A structural member design method according to a first aspect of the present invention is
a structural member design method, a structural member being obtained by forming a tailored blank,
the tailored blank including a linear weld formed by butt-welding two or more steel sheets, and
the steel sheet before being butt-welded including, on a surface of a base steel sheet, an exposed portion where the base steel sheet is exposed at a part of a joined end portion to be butt-welded of a plated steel sheet in which an intermetallic compound layer and an aluminum plating layer are disposed in this order from the base steel sheet side,
the structural member design method including:
a weld setting step of performing crash analysis by numerical simulation on an analytical model of the structural member, and setting the position of the weld such that a fracture index of a first region that is at least a part of the weld in an extending direction of the weld is equal to or more than a specified value, and the fracture indices of all remaining regions other than the first region in the weld are less than the specified value; and
a removal region setting step of setting, after the weld setting step, a region including a portion corresponding to the first region in the joined end portion as a removal region where the exposed portion is formed.

(2) A second aspect of the present invention is the structural member design method according to the first aspect, in which
the structural member includes a flange section to be joined to another member, and the first region may be located in the flange section.

(3) A steel sheet manufacturing method according to a third aspect of the present invention is
a steel sheet manufacturing method used for manufacturing a structural member designed by the structural member design method according to the first or second aspect, the steel sheet manufacturing method including:
a step of providing a plated steel sheet in which the intermetallic compound layer and the aluminum plating layer are disposed in this order from the base steel sheet side on a surface of the base steel sheet; and
a removal step of removing a part of the aluminum plating layer and the intermetallic compound layer in the removal region to form an exposed portion where the base steel sheet is exposed, a first plated portion in which the intermetallic compound layer and the aluminum plating layer remain in this order from the base steel sheet side on the surface of the base steel sheet, and a second plated portion in which the intermetallic compound layer and the aluminum plating layer remain on the surface of the base steel sheet, in which
in the removal step, a part of the aluminum plating layer and the intermetallic compound layer is removed such that the first plated portion, the exposed portion, the second plated portion, and one end edge of the plated steel sheet are disposed in this order on one surface of the base steel sheet in a first direction perpendicular to a thickness direction of the plated steel sheet and directed from a center portion of the plated steel sheet to the end edge of the plated steel sheet in plane view, and such that at least the first plated portion, the exposed portion, and the end edge of the plated steel sheet are disposed in this order on the other surface of the base steel sheet in the first direction.

(4) A steel sheet manufacturing method according to a fourth aspect of the present invention is
a steel sheet manufacturing method used for manufacturing a structural member designed by the structural member design method according to the first or second aspect, the steel sheet manufacturing method including:
a step of providing a plated steel sheet in which the intermetallic compound layer and the aluminum plating layer are disposed in this order from the base steel sheet side on a surface of the base steel sheet; and
a removal step of removing a part of the aluminum plating layer and the intermetallic compound layer in the removal region to form an exposed portion where the base steel sheet is exposed and a first plated portion in which the intermetallic compound layer and the aluminum plating layer remain in this order from the base steel sheet side on the surface of the base steel sheet, in which
in the removal step, a part of the aluminum plating layer and the intermetallic compound layer is removed such that the first plated portion, the exposed portion, and one end edge of the plated steel sheet are disposed in this order on one surface of the base steel sheet in a first direction perpendicular to a thickness direction of the plated steel sheet and directed from a center portion of the plated steel sheet to the end edge of the plated steel sheet in plane view, and such that at least the first plated portion, the exposed portion, and the end edge of the plated steel sheet are disposed in this order on the other surface of the base steel sheet in the first direction.

(5) A tailored blank manufacturing method according to a fifth aspect of the present invention includes a step of butt-welding steel sheets manufactured by the steel sheet manufacturing method according to the third or fourth aspect.

(6) A structural member manufacturing method according to a sixth aspect of the present invention includes a step of hot-stamping a tailored blank manufactured by the tailored blank manufacturing method according to the fifth aspect.

(7) A structural member according to a seventh aspect of the present invention is
a structural member having a linear weld formed therein, the structural member including two or more steel members joined by the weld, in which
each of the steel members includes:
a base metal; and
a plated layer disposed on a surface of the base metal,
the steel members include exposed portions where the base metal is exposed in regions adjacent to each other along the weld, and
the exposed portions are partially present in an extending direction of the weld.

(8) An eighth aspect of the present invention is the structural member according to the seventh aspect, in which the exposed portion may be present in a portion corresponding to a fracture assumed portion in the structural member.

(9) A ninth aspect of the present invention is the structural member according to the seventh or eighth aspect, including:
a top sheet portion;
a pair of side wall portions bent and connected from an end portion of the top sheet portion;
a first ridge portion connecting the top sheet portion and the side wall portions;
a pair of flange sections bent and connected from end portions of the side wall portions; and
a second ridge portion connecting the side wall portions and the flange sections, in which
the exposed portion may be present in a portion other than the side wall portions.

(10) A tenth aspect of the present invention is the structural member according to the ninth aspect, in which
the exposed portion may be present only in the flange section.

### Effects of the Invention

According to the above aspects of the present invention, it is possible to provide a method for designing a structural member having a flange section, a steel sheet manufacturing method, a tailored blank manufacturing method, and a method for manufacturing a structural member having a flange section, capable of suppressing fracture of the structural member having a flange section, shortening time for removing aluminum plating, and prolonging a life of a tool.

### BRIEF DESCRIPTION OF THE DRAWINGS

FIG. 1 is a perspective view illustrating an example of a structural member.

FIG. 2 is a cross-sectional view of the structural member of FIG. 1, taken along line A-A.

FIG. 3 is a flowchart of a structural member design method of the present disclosure.

FIG. 4 is an explanatory diagram for explaining crash analysis.

FIG. 5 is a diagram illustrating a result of crash analysis.

FIG. 6 is a schematic view for explaining a removal region.

FIG. 7 is a schematic cross-sectional view illustrating an example of an end portion of a base steel sheet in a steel sheet used for a flange structural member of the present disclosure, the end portion having an exposed portion and a second plated portion.

FIG. 8 is a flowchart of a steel sheet manufacturing method and a tailored blank manufacturing method of the present disclosure.

FIG. 9 is a cross-sectional view for explaining a lower portion forming step in the steel sheet manufacturing method of the present disclosure.

FIG. 10 is a cross-sectional view for explaining the lower portion forming step in the steel sheet manufacturing method of the present disclosure.

FIG. 11 is a cross-sectional view for explaining the lower portion forming step in the steel sheet manufacturing method of the present disclosure.

FIG. 12 is a cross-sectional view for explaining a cutting step in the steel sheet manufacturing method of the present disclosure.

FIG. 13 is a cross-sectional view for explaining the cutting step in the steel sheet manufacturing method of the present disclosure.

FIG. 14 is a cross-sectional view for explaining the cutting step in the steel sheet manufacturing method of the present disclosure.

FIG. 15 is a schematic cross-sectional view of a tailored blank of the present disclosure.

FIG. 16 is a cross-sectional view of the structural member of FIG. 1, taken along line B-B.

FIG. 17 is an explanatory diagram of a removal region of Example 1.

FIG. 18 is a diagram illustrating an analysis result of Example 2.

FIG. 19 is an explanatory diagram of a removal region of Example 2.

FIG. 20 is an explanatory view of a removal region of Comparative Example 1.

FIG. 21 is a diagram illustrating a relationship between a height from a vehicle lower end and an intrusion amount in Examples and Comparative Examples.

### EMBODIMENT OF THE INVENTION

As a result of intensive studies by the present inventors, it has been found that a tensile force is not applied to an entire region of a linear weld at the time of collision in a structural member obtained by forming a tailored blank. Therefore, there is a region from which an aluminum plating layer and an intermetallic compound layer do not need to be removed in the structural member. In the present disclosure, by performing crash analysis on a structural member obtained by forming a tailored blank using numerical simulation, the structural member is designed such that a portion having a high risk of being fractured by a tensile force or local bending deformation being applied to the portion in a weld is only a first region which is at least a part of the weld in an extending direction thereof. By designing the structural member in this manner, a range from which the aluminum plating layer and the intermetallic compound layer are removed can be only the first region. As a result, the strength of the weld can be maintained in the first region having a large load. In a region having a small load, it is not necessary to remove the aluminum plating layer and the intermetallic compound layer. Therefore, processing time required for removing the aluminum plating layer and the intermetallic compound layer can be shortened, and a life of a tool can be prolonged.

### Structural Member Design Method

Hereinafter, a structural member design method of the present disclosure will be described with reference to the drawings.

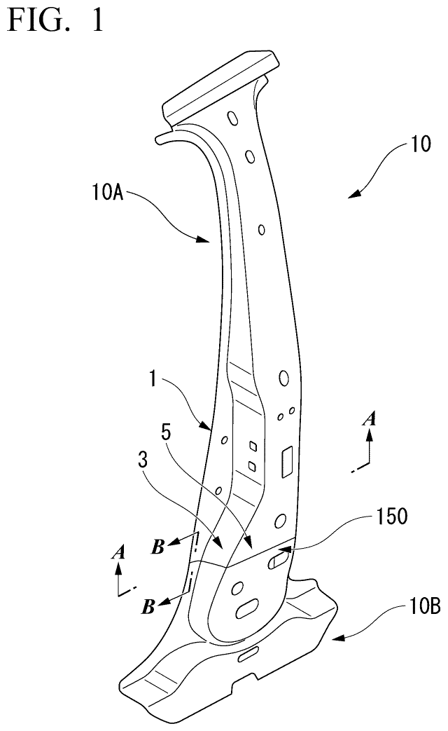

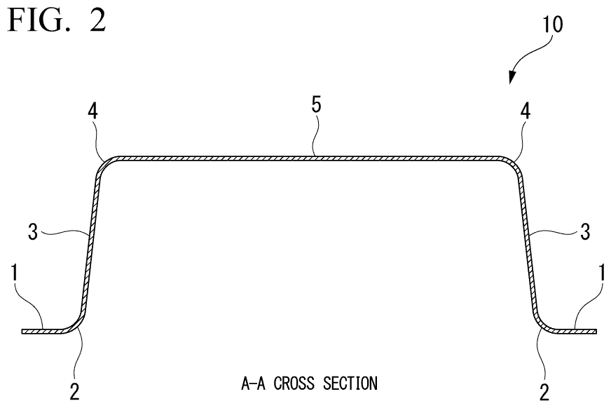

The structural member of the present disclosure is, for example, a structural member for an automobile, and examples thereof include a B-pillar, a bumper, and a side sill. FIGS. 1 and 2 illustrate an example of the structural member of the present disclosure, but the structural member of the present disclosure is not limited to the shape of FIGS. 1 and 2. FIG. 1 is a perspective view of the structural member. FIG. 2 is a cross-sectional view of the structural member 10 of FIG. 1, taken along line A-A. The structural member 10 in FIGS. 1 and 2 is a B-pillar including a member (steel member) 10A, a member (steel member) 10B, and a linear weld 150 connecting the member 10A and the member 10B. The structural member 10 will be described later. The structural member 10 includes at least a flange section 1, a first ridge portion 2, a side wall portion 3, a second ridge portion 4, and a top sheet portion 5. The member 10A and the member 10B may have the same or different tensile strength, thickness, and the like. Note that the structural member 10 is obtained by hot-stamping a tailored blank. The tailored blank used for the structural member 10 includes a linear weld formed by butt-welding two or more steel sheets (steel sheets for butt welding). The steel sheet (steel sheet before butt welding) used for manufacturing the tailored blank includes, on a surface of a base steel sheet, an exposed portion where the base steel sheet is exposed in a part of an end portion (joined end portion to be butt-welded) of a plated steel sheet in which an intermetallic compound layer and an aluminum plating layer are disposed from the base steel sheet side. The steel sheet used for the tailored blank of the present disclosure will be described later. Hereinafter, a structural member design method will be described. In the present specification, the meaning of the term “step” includes not only an independent step but also a step that cannot be clearly distinguished from other steps as long as an intended purpose of the step can be achieved.

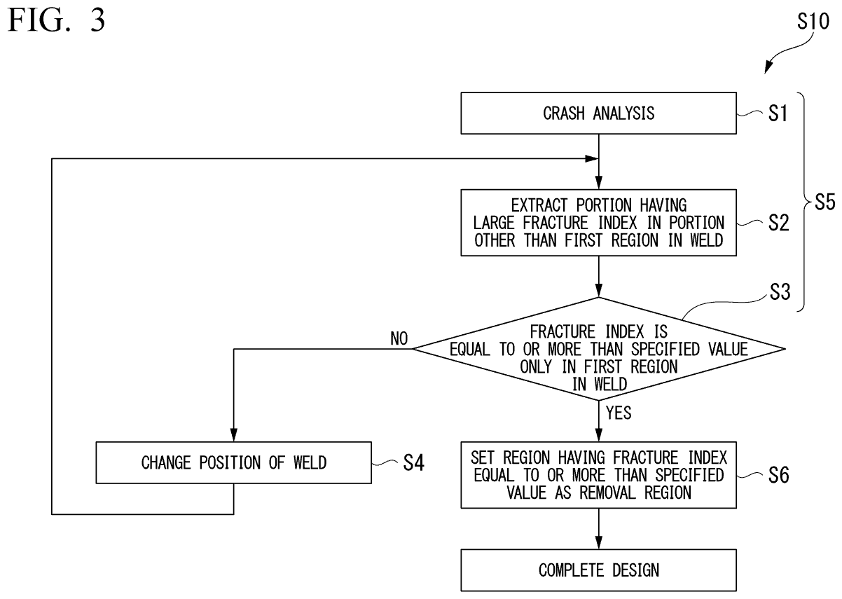

A structural member design method S10 of the present disclosure will be described with reference to FIG. 3. FIG. 3 is a flowchart of the structural member design method of the present disclosure. The structural member design method S10 of the present disclosure includes: a weld setting step S5 of performing crash analysis by numerical simulation on an analytical model of the structural member 10, and setting the position of a weld such that a fracture index of a first region which is at least a part of the weld 150 in an extending direction thereof is equal to or more than a specified value and fracture indices of all remaining regions other than the first region in the weld 150 are less than the specified value; and a removal region setting step of setting, after the weld setting step S5, a region including a portion corresponding to the first region in a joined end portion as a removal region where an exposed portion is formed. For example, when only a flange section is set as the first region, for example, the structural member design method S10 includes: a weld setting step S5 of performing crash analysis by numerical simulation on the structural member 10, and setting the position of the weld 150 such that a fracture index of a flange section 1 of the structural member 10 in the weld 150 is equal to or more than a specified value and fracture indices of regions other than the flange section 1 of the structural member 10 in the weld 150 are less than the specified value; and a removal region setting step S6 of setting, after the weld setting step S5, a region including at least an end portion of a plated steel sheet, the region having a fracture index equal to or more than a specified value in the crash analysis and corresponding to a region where the weld is formed, as a removal region from which an aluminum plating layer and the intermetallic compound layer are removed. Hereinafter, a case where the first region is only the flange section 1 will be described as an example, but the present invention is not limited thereto. For example, the first region may be located in any one or more of the flange section 1, the first ridge portion 2, the second ridge portion 4, and the top sheet portion 5. The first region can be appropriately set. The first region is preferably located only in the flange section 1. When the first region from which the plated layer is to be removed is located in the flange section 1, it is possible to avoid that the weld 150 in the flange section 1 joined to another member is quickly fractured. Therefore, when a load is applied, it is possible to maintain joining with another member as much as possible. As a result, it is possible to improve load bearing performance of a member such as a frame member of an automobile having a structure in which another member is joined at a flange section of a structural member.

### Weld Setting Step

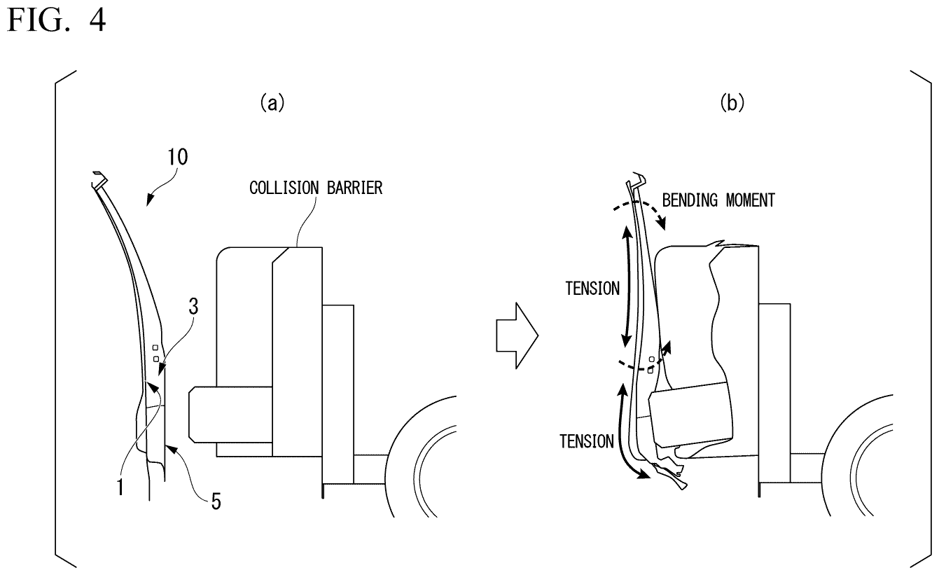

In the weld setting step S5, crash analysis is first performed on the structural member 10 (S1). Specifically, crash analysis by numerical simulation is performed on an analytical model of the structural member 10. The crash analysis will be described with reference to FIG. 4. FIG. 4(a) illustrates a positional relationship between the structural member 10 and a collision barrier, and FIG. 4(b) illustrates directions of a bending moment and a tensile force at the time of collision. In the example of FIG. 4, a portion where the collision barrier collides is an energy absorbing region, and is largely deformed. Specifically, the top sheet portion 5 and the side wall portion 3 at the collision portion are subjected to bending deformation or crushing deformation. At this time, since the flange section 1 is generally disposed on a bending outer side, tensile strain occurs. On the other hand, an upper side of the structural member 10 receives a bending moment due to intrusion of the collision barrier. Therefore, since the flange section 1 located on the upper side is disposed on the bending outer side similarly to the flange section 1 located on a lower side of the structural member 10, tensile strain occurs. Therefore, tensile strain occurs over the total length of the flange section 1. Therefore, a fracture risk is high even when the weld is located at any position. On the other hand, when the weld is present at a position where bending deformation occurs even in a portion other than the flange section 1 (for example, the top sheet portion 5), the fracture risk is high. This fracture can be avoided by changing the position of the weld. In order to grasp the fracture risk in a portion other than the first region (here, the flange section 1), crash analysis is performed.

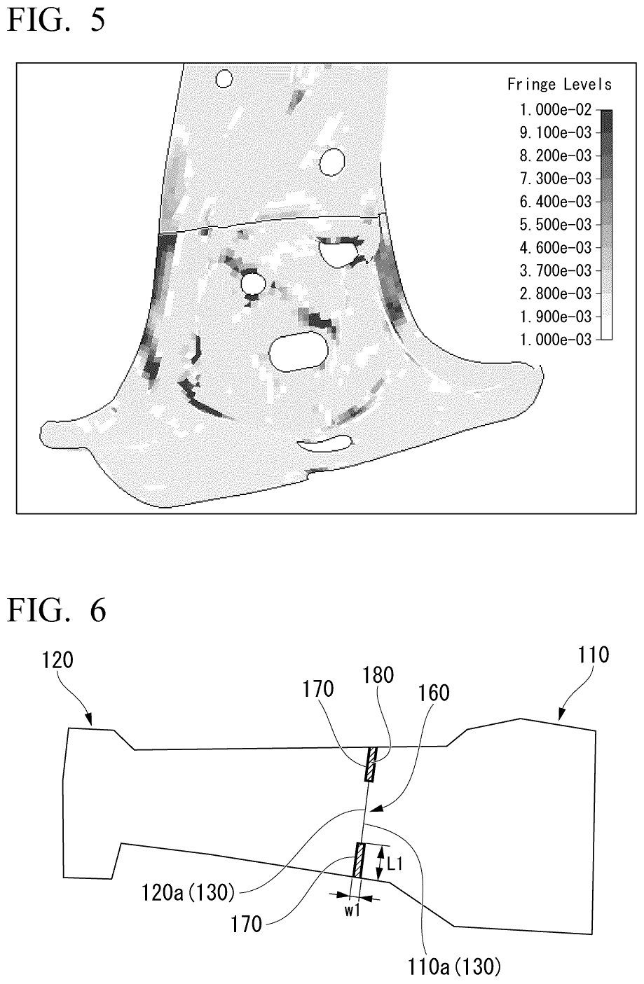

In the crash analysis S1, crash analysis is performed on an analytical model of the structural member by numerical simulation. The numerical simulation is not particularly limited, and for example, a finite element method, a difference method, or a boundary element method can be used. The crash analysis can be performed using, for example, software such as LS-DYNA (registered trademark), and analysis of a fracture index can be performed using NSafe (registered trademark)-MAT. FIG. 5 is a diagram illustrating a result of the crash analysis. As illustrated in FIG. 5, a portion having a high fracture index (a portion having a high fracture risk) can be identified by performing the crash analysis. Examples of the fracture index include strain, stress, and a sheet thickness reduction ratio. As the fracture index, strain is preferable.

Conditions (collision direction, collision speed, tensile strength of structural member, and the like) used for the crash analysis are not particularly limited, and can be appropriately set according to an application for which the structural member is used. For example, in a case of the structural member 10, for example, analysis in side crash is performed using a full car model.

After the crash analysis (S1) is performed, a portion having a large fracture index in a portion other than the first region is extracted in the weld 150 (S2). Next, it is confirmed whether or not fracture indices of all portions extracted in S2 are less than a specified value. That is, it is confirmed whether or not a region having a fracture index equal to or more than the specified value (also referred to as a fracture assumed portion) is only the first region (here, the flange section 1) of the weld 150 (S3). Here, the specified value is, for example, a threshold at which fracture occurs in the fracture index. In the weld 150, when there is a region having a fracture index equal to or more than the specified value in all remaining regions other than the first region, the position of the weld 150 is changed (S4), and the crash analysis is performed again (S1). When the region having a fracture index equal to or more than the specified value is only the first region of the weld 150, the removal region setting step S6 is performed. A method for changing the position of the weld 150 is not particularly limited. For example, when a door hinge mounting portion is included, the position of the weld 150 can be changed such that the weld 150 does not enter the door hinge mounting portion.

In the removal region setting step S6, after the weld setting step S5, a region of an end portion of a steel sheet (steel sheet for butt welding) corresponding to a region (high-load region) in which a fracture index is equal to or more than the specified value in the crash analysis and the weld 150 is formed is set as a removal region from which an aluminum plating layer and an intermetallic compound layer are removed. In other words, in the removal region setting step S6, a region including at least a portion corresponding to the first region in a joined end portion is set as a removal region where an exposed portion is formed. FIG. 6 is a schematic view for explaining a removal region 170. Here, the high-load region is a first region 180. The shape of a steel sheet 120 to be the member 10A and the shape of a steel sheet 110 to be the member 10B are each set so as to be the shape of the structural member 10 by hot press forming and such that a welding scheduled position 160 is the position of the weld 150 set in the weld setting step S5. An end portion 110a of the steel sheet 110 and an end portion 120a of the steel sheet 120 along the welding scheduled position 160 are joined end portions 130 to be butt-welded. The removal region 170 includes a high-load region. The length L1 of the removal region in a longitudinal direction is preferably three times or less the length of the high-load region in the longitudinal direction. The length L1 is more preferably twice or less the length of the high-load region in the longitudinal direction. The length of the removal region 170 may be equal to that of the high-load region. That is, the removal region may be only the high-load region. The length W1 of the removal region in a direction perpendicular to the longitudinal direction is preferably longer than the width of a region where the weld 150 is to be formed (the length of the weld in a direction perpendicular to the longitudinal direction). Since the aluminum plating layer and the intermetallic compound layer 16 are not removed except for the removal region, mass productivity of the steel sheet used for the structural member 10 is improved.

### Steel Sheet

Next, the steel sheet 110 and the steel sheet 120 in FIG. 6 will be described. Each of the steel sheets (steel sheets for butt welding) 110 and 120 of the present disclosure is a steel sheet that is butt-welded to another steel sheet to form a tailored blank.

Note that a numerical range represented using “to” in the present specification means a range including numerical values described before and after “to” as a lower limit value and an upper limit value.

In the present specification, as for the content of a component (element), for example, the content of C (carbon) may be described as “C content”. In addition, the contents of other elements may be described similarly.

In the present disclosure, the terms “base steel sheet”, “intermetallic compound layer”, and “aluminum plating layer” will be described in “Specifying ranges of base steel sheet, intermetallic compound layer, and aluminum plating layer” described later in the first aspect.

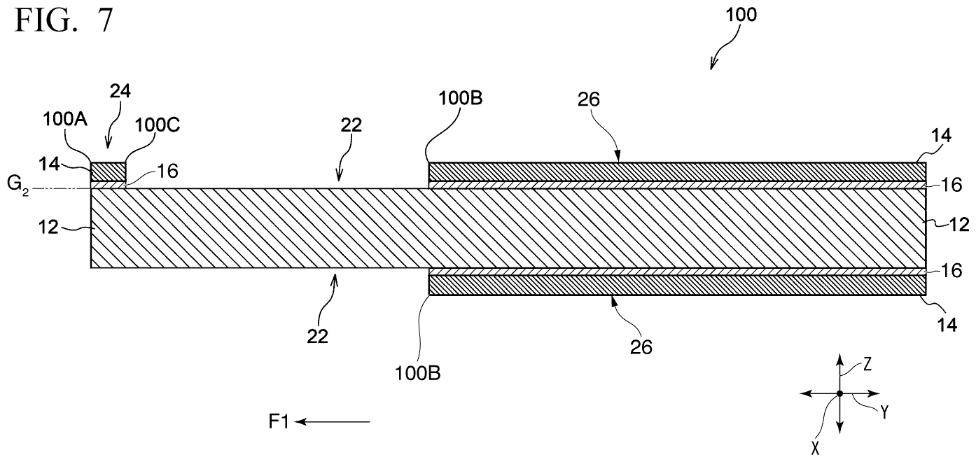

In the present disclosure, the term “cross section” of a steel sheet (steel sheet for butt welding) means a cross section cut in a thickness (sheet thickness) direction of the steel sheet. Specifically, in FIG. 7, the thickness direction of the steel sheet 100 is defined as Z, and a longitudinal direction of the exposed portion 22 (direction orthogonal to a display surface in FIG. 7) is defined as X. A direction orthogonal to the direction Z and the direction X is defined as Y. At this time, the cross section means a cross section cut along a YZ plane.

In the present disclosure, the term “thickness direction” means a direction in which the sheet thickness of a sheet width center portion of a steel sheet is measured.

In the present disclosure, the term “plating thickness” means a length of a steel sheet from a surface of a first plated portion or a second plated portion to a base steel sheet in the thickness direction.

In the present disclosure, the term “end surface of a steel sheet” means a surface exposed in a direction orthogonal to the thickness direction among surfaces of a steel sheet.

In the present disclosure, the term “end edge of a steel sheet” means a portion adjacent to an end surface of a steel sheet.

In the present disclosure, the term “end portion of a steel sheet” means a region located around a steel sheet and ranging within 20% from an end surface of the steel sheet with respect to an opposing width of the steel sheet (that is, a length from an end edge to an end edge of an opposing steel sheet).

The steel sheet of the present disclosure forms a tailored blank by an end surface in an end portion and an end surface of another steel sheet being butt-welded. Here, as an aspect of the two steel sheets to be butt-welded, any one of the following aspects can be adopted.

A steel sheet used for the structural member of the present disclosure includes a base steel sheet, an intermetallic compound layer, and an aluminum plating layer. In addition, the steel sheet of the present disclosure has, on a surface of the base steel sheet, a first plated portion in which the intermetallic compound layer and the aluminum plating layer are disposed in this order from the base steel sheet side. In addition, the steel sheet of the present disclosure has an exposed portion where the base steel sheet is exposed in the removal region 170 set in the removal region setting step S6. In addition, the steel sheet of the present disclosure has, on the surface of the base steel sheet, a second plated portion in which the intermetallic compound layer and the aluminum plating layer are disposed in this order from the base steel sheet side in the removal region 170 set in the removal region setting step S6.

Here, a direction (Y direction) perpendicular to the thickness direction of the steel sheet and directed from the first plated portion to one end edge of the steel sheet is defined as a first direction. In the steel sheet of the present disclosure, in the first direction, the first plated portion, the exposed portion, the second plated portion, and the end edge of the steel sheet are disposed in this order of the first plated portion, the exposed portion, the second plated portion, and the end edge of the steel sheet on at least one surface of the base steel sheet. In addition, in the steel sheet of the present disclosure, in the first direction, at least the first plated portion, the exposed portion, and the end edge of the steel sheet are disposed in this order on the other surface of the base steel sheet.

Note that, in the first direction, the first plated portion, the exposed portion, the second plated portion, and the end edge of the steel sheet may be disposed in this order on the other surface of the base steel sheet.

Note that the steel sheet of the present disclosure is formed as a tailored blank by an end surface of an end portion thereof being butt-welded to an end surface of another steel sheet. The shape of the another steel sheet is not particularly limited.

FIG. 7 is an example of a steel sheet used as the steel sheets 110 and 120 used in FIG. 6. FIG. 7 is a schematic cross-sectional view illustrating an example of an end portion in which a first plated portion, an exposed portion of a base steel sheet, and a second plated portion including an intermetallic compound layer and an aluminum plating layer are disposed on one surface of the steel sheet of the present disclosure, and the first plated portion and the exposed portion are disposed on the other surface. That is, FIG. 7 illustrates an aspect in which the first plated portion, the exposed portion, and the second plated portion are disposed on one surface of the steel sheet, and the second plated portion includes the intermetallic compound layer and the aluminum plating layer. In addition, in an end portion on the other surface of the steel sheet illustrated in FIG. 7, the first plated portion and the exposed portion are disposed, but the second plated portion is not disposed, and the exposed portion extends to an end edge of the steel sheet.

In FIG. 7, reference numeral 100 denotes a steel sheet, reference numeral 12 denotes a base steel sheet, reference numeral 14 denotes an aluminum plating layer, reference numeral 16 denotes an intermetallic compound layer, reference numeral 22 denotes an exposed portion, reference numeral 24 denotes a second plated portion, and reference numeral 26 denotes a first plated portion.

Reference numeral 100A denotes an end edge of the steel sheet 100. Reference numeral 100B denotes an end edge of the first plated portion 26 on a boundary between the first plated portion 26 and the exposed portion 22. Reference numeral 100C denotes an end edge of the second plated portion 24 on a boundary between the second plated portion 24 and the exposed portion 22.

The steel sheet 100 of the present disclosure includes a base steel sheet 12, an intermetallic compound layer 16, and an aluminum plating layer 14. The steel sheet 100 of the present disclosure has, on a surface of the base steel sheet 12, the first plated portion 26 in which the intermetallic compound layer 16 and the aluminum plating layer 14 are disposed in this order from the base steel sheet 12 side. In addition, the steel sheet 100 of the present disclosure has the exposed portion 22 where the base steel sheet 12 is exposed in a removal region. In addition, the steel sheet 100 of the present disclosure has, on the surface of the base steel sheet 12, the second plated portion 24 including the intermetallic compound layer 16 and the aluminum plating layer 14.

Here, a direction perpendicular to the thickness direction of the steel sheet 100 and directed from the first plated portion 26 to the one end edge 100A of the steel sheet 100 is defined as a first direction F1. In the steel sheet 100 of the present disclosure, in the first direction F1, the first plated portion 26, the exposed portion 22, the second plated portion 24, and the end edge 100A of steel sheet 100 are disposed on the same plane in this order of the first plated portion 26, the exposed portion 22, the second plated portion 24, and the end edge 100A of steel sheet 100.

The exposed portion 22 is formed in a region between the end edge 100B of the first plated portion 26 and the end edge 100C on a boundary between the second plated portion 24 and the exposed portion 22. The exposed portion 22 is formed between the first plated portion 26 and the second plated portion 24.

The second plated portion 24 is formed in a region including the end edge 100A of the steel sheet 100. In the first direction F1, the end edge 100A of the steel sheet 100 and the second plated portion 24 are adjacent to each other. The second plated portion 24 is formed in a region between the end edge 100A of the steel sheet 100 and the end edge 100C on a boundary between the second plated portion 24 and the exposed portion 22.

The second plated portion 24, the exposed portion 22, and the first plated portion 26 are formed on one surface of an end portion of the steel sheet 100, and the exposed portion 22 and the first plated portion 26 are formed on the other surface of the end portion.

In the steel sheet 100 of the present disclosure, as illustrated in FIG. 7, in the end portion of the steel sheet 100, the thickness of the base steel sheet 12 in the exposed portion 22 where the base steel sheet 12 is exposed may be the same as the thickness of the base steel sheet 12 in the first plated portion 26. In addition, in the steel sheet 100 of the present disclosure, in the end portion of the steel sheet 100, the thickness of the base steel sheet 12 in the exposed portion 22 where the base steel sheet 12 is exposed may be smaller than the thickness of the base steel sheet 12 in the first plated portion 26.

The steel sheet of the present disclosure has been described above with reference to FIG. 7, but the steel sheet of the present disclosure is not limited thereto.

### Base Steel Sheet

The aluminum plating layer 14 is disposed on a surface of the base steel sheet 12. The base steel sheet 12 is not particularly limited as long as it is obtained by an ordinary method including a hot rolling step, a cold rolling step, a plating step, and the like. The base steel sheet may be either a hot-rolled steel sheet or a cold-rolled steel sheet.

The thickness of the base steel sheet 12 only needs to be a thickness according to a purpose, and is not particularly limited. For example, the thickness of the base steel sheet 12 may be such a thickness that the thickness of the entire plated steel sheet (steel sheet before the exposed portion 22 and the like are formed) after the aluminum plating layer 14 is disposed is 0.8 mm or more or 1 mm or more. In addition, the thickness of the base steel sheet 12 may be such a thickness that the thickness is 4 mm or less or 3 mm or less.

As the base steel sheet 12, for example, a steel sheet formed so as to have high mechanical strength (which means, for example, various properties related to mechanical deformation and fracture, such as tensile strength, yield point, elongation, drawing, hardness, impact value, and fatigue strength.) is favorably used. Specifically, a steel sheet having tensile strength of 400 to 2700 MPa which is currently easily available is exemplified, but the base steel sheet 12 is not limited thereto. The sheet thickness is, for example, 0.7 mm to 3.2 mm. Note that, as the base steel sheet 12, a steel sheet having low mechanical strength may be used. Specific examples thereof include 1300 MPa class, 1200 MPa class, 1000 MPa class, 600 MPa class, and 500 MPa class. For example, in a case of a B-pillar of an automobile, a steel sheet having high tensile strength is used from an upper portion to a center portion where deformation is to be prevented, and a steel sheet having lower tensile strength is used for a lower portion which is an energy absorbing portion. From the upper portion to the center portion, a steel sheet of 1500 to 2700 MPa class is desirably used as a steel sheet which is currently easily available. It is desirable to use a steel sheet having tensile strength of 500 MPa class to 1800 MPa class for the lower portion. More preferably, the lower portion is a steel sheet of 600 MPa class to 1300 MPa class. The sheet thickness of the upper portion of the steel sheet of the B-pillar is desirably 1.4 mm to 2.6 mm, and the sheet thickness of the lower portion of the steel sheet of the B-pillar is desirably 1.0 mm to 1.6 mm.

Examples of a preferable chemical composition of the base steel sheet 12 include the following chemical compositions.

The base steel sheet 12 has a chemical composition consisting of, in terms of mass %, C: 0.02% to 0.58%, Mn: 0.20% to 3.00%, Al: 0.005% to 0.06%, P: 0.03% or less, S: 0.010% or less, N: 0.010% or less, Ti: 0% to 0.20%, Nb: 0% to 0.20%, V: 0% to 1.0%, W: 0% to 1.0%, Cr: 0% to 1.0%, Mo: 0% to 1.0%, Cu: 0% to 1.0%, Ni: 0% to 1.0%, B: 0% to 0.0100%, Mg: 0% to 0.05%, Ca: 0% to 0.05%, REM: 0% to 0.05%, Sn: 0% to 0.5%, Bi: 0% to 0.05%, Si: 0% to 2.00%, and a remainder: Fe and impurities.

Note that, hereinafter, “%” indicating the content of a component (element) means “mass %”.

(C: 0.02% to 0.58%)

C is an important element that increases hardenability of the base steel sheet 12 and mainly determines post-quenching strength. Furthermore, C is an element that lowers an A₃ point and promotes lowering of a quenching temperature. When the C content is less than 0.02%, an effect thereof is not sufficient in some cases. Therefore, the C content is favorably 0.02% or more. On the other hand, when the C content is more than 0.58%, toughness of a quenched portion is significantly deteriorated. Therefore, the C content is favorably 0.58% or less. The C content is preferably 0.45% or less.

(Mn: 0.20% to 3.00%)

Mn is a very effective element for enhancing hardenability of the base steel sheet 12 and stably ensuring post-quenching strength. When the Mn content is less than 0.20%, an effect thereof is not sufficient in some cases. Therefore, the Mn content is favorably 0.20% or more. The Mn content is more preferably 0.80% or less. On the other hand, when the Mn content is more than 3.00%, not only an effect thereof is saturated, but also it may be rather difficult to ensure stable strength after quenching. Therefore, the Mn content is favorably 3.00% or less. The Mn content is more preferably 2.40% or less.

(Al: 0.005% to 0.06%)

Al functions as a deoxidizing element and has an action of making the base steel sheet 12 sound. When the Al content is less than 0.005%, it may be difficult to obtain an effect of the above action. Therefore, the Al content is favorably 0.005% or more. On the other hand, when the Al content is more than 0.06%, the effect of the above action is saturated, which is disadvantageous in terms of cost. Therefore, the Al content is favorably 0.06% or less. The Al content is preferably 0.05% or less. in addition, the Al content is preferably 0.01% or more.

(P: 0.03% or less)

P is an element contained as an impurity. When P is excessively contained, toughness of the base steel sheet 12 tends to decrease. Therefore, the P content is favorably 0.03% or less. The P content is preferably 0.01% or less. A lower limit of the P content is not particularly limited, but is preferably 0.0002% from a viewpoint of cost.

(S: 0.010% or less)

S is an element contained as an impurity. S has an action of forming MnS and embrittling the base steel sheet 12. Therefore, the S content is favorably 0.010% or less. The S content is more desirably 0.004% or less. A lower limit of the S content does not need to be particularly specified, but is preferably 0.0002% from a viewpoint of cost.

(N: 0.010% or less)

N is an element contained as an impurity in the base steel sheet 12. Furthermore, N is an element that forms an inclusion in the base steel sheet 12 and deteriorates toughness after hot press forming. Therefore, the N content is favorably 0.010% or less. The N content is preferably 0.008% or less, and more preferably 0.005% or less. A lower limit of the N content does not need to be particularly specified, but is preferably 0.0002% from a viewpoint of cost.

(Ti: 0% to 0.20%, Nb: 0% to 0.20%, V: 0% to 1.0%, W: 0% to 1.0%)

Ti, Nb, V, and W are elements that promote interdiffusion of Fe and Al in the aluminum plating layer and the base steel sheet 12. Therefore, at least one or more of Ti, Nb, V, and W may be contained in the base steel sheet 12. However, when 1) each of the Ti content and the Nb content is more than 0.20%, or 2) each of the V content and the W content is more than 1.0%, an effect of the above action is saturated, which is disadvantageous in terms of cost. Therefore, each of the Ti content and the Nb content is favorably 0.20% or less, and each of the V content and the W content is favorably 1.0% or less. Each of the Ti content and the Nb content is preferably 0.15% or less, and each of the V content and the W content is preferably 0.5% or less. In order to more reliably obtain the effect of the above action, a lower limit of each of the Ti content and the Nb content is preferably 0.01%, and a lower limit of each of the V content and the W content is preferably 0.1%.

(Cr: 0% to 1.0%, Mo: 0% to 1.0%, Cu: 0% to 1.0%, Ni: 0% to 1.0%, B: 0% to 0.0100%)

Cr, Mo, Cu, Ni, and B are effective elements for enhancing hardenability of the base steel sheet 12 and stably ensuring post-quenching strength. Therefore, one or more of these elements may be contained in the base steel sheet 12. However, even when the content of each of Cr, Mo, Cu, and Ni is more than 1.0%, and the B content is more than 0.0100%, the above effect is saturated, which is disadvantageous in terms of cost. Therefore, the content of each of Cr, Mo, Cu, and Ni is favorably 1.0% or less. The B content is favorably 0.0100% or less, and preferably 0.0080% or less. In order to more reliably obtain the above effect, it is preferable to satisfy either one of the content of each of Cr, Mo, Cu, and Ni of 0.1% or more and the B content of 0.0010% or more.

(Ca: 0% to 0.05%, Mg: 0% to 0.05%, REM: 0% to 0.05%)

Ca, Mg, and REM have an action of refining a form of an inclusion in steel and preventing occurrence of cracking during hot press forming due to the inclusion. Therefore, one or more of these elements may be contained in the base steel sheet 12. However, when these elements are excessively added, the effect of refining the form of the inclusion in the base steel sheet 12 is saturated, which causes only an increase in cost. Therefore, the Ca content is 0.05% or less, the Mg content is 0.05% or less, and the REM content is 0.05% or less. In order to more reliably obtain the effect of the above action, it is preferable to satisfy any of the Ca content of 0.0005% or more, the Mg content of 0.0005% or more, and the REM content of 0.0005% or more.

Here, REM refers to 17 elements of Sc, Y, and lanthanoid, and the content of REM refers to the total content of these elements. Lanthanoid is industrially added to the base steel sheet 12 in a form of misch metal.

(Sn: 0% to 0.5%)

Sn is an element that improves corrosion resistance of the exposed portion 22. Therefore, Sn may be contained in the base steel sheet 12. However, when Sn is contained in the base steel sheet 12 in an amount of more than 0.5%, embrittlement of the base steel sheet 12 is caused. Therefore, the Sn content is 0.5% or less. The Sn content is preferably 0.3% or less. Note that, in order to more reliably obtain an effect of the above action, the Sn content is preferably 0.02% or more. The Sn content is more preferably 0.04% or more.

(Bi: 0% to 0.05%)

Bi is an element that acts as a solidification nucleus in a solidification process of molten steel and has an action of suppressing segregation of Mn or the like segregated in a secondary arm interval of dendrite by reducing the secondary arm interval of dendrite. Therefore, Bi may be contained in the base steel sheet 12. In particular, for a steel sheet that often contains a large amount of Mn, such as a steel sheet for hot stamping, Bi is effective in suppressing deterioration of toughness due to segregation of Mn. Therefore, Bi is preferably contained in such a kind of steel.

However, even when Bi is contained in the base steel sheet 12 in an amount of more than 0.05%, an effect of the above action is saturated, leading to an increase in cost. Therefore, the Bi content is 0.05% or less. The Bi content is preferably 0.02% or less. Note that, in order to more reliably obtain an effect of the above action, the Bi content is preferably 0.0002% or more. The Bi content is more preferably 0.0005% or more.

(Si: 0% to 2.00%)

Si is a solid-solution strengthening element, and can be effectively utilized when Si is contained in an amount up to 2.00%. However, when Si is contained in the base steel sheet 12 in an amount of more than 2.00%, there is a concern that defects may occur in plating properties. Therefore, when the base steel sheet 12 contains Si, the Si content is favorably 2.00% or less. An upper limit is preferably 1.40% or less, and more preferably 1.00% or less. A lower limit is not particularly limited, but is preferably 0.01% in order to more reliably obtain an effect of the above action.

### Remainder

Fe and impurities are contained as a remainder. Here, examples of the impurities include a component contained in a raw material such as ore or scrap, and a component mixed in a steel sheet in a manufacturing process. The impurity means a component that is not intentionally contained in a steel sheet.

### Aluminum Plating Layer

The aluminum plating layer 14 is formed on each of surfaces of the base steel sheet 12. A method for forming the aluminum plating layer 14 is not particularly limited. For example, the aluminum plating layer 14 may be formed on each of surfaces of the base steel sheet 12 by a hot-dip plating method (method for immersing the base steel sheet 12 in a molten metal bath mainly containing aluminum to form an aluminum plating layer).

Here, the aluminum plating layer 14 is a plated layer mainly containing aluminum, and only needs to contain 50 mass % or more of aluminum. The aluminum plating layer 14 may contain an element other than aluminum (for example, Si) according to a purpose, and may contain impurities mixed in a manufacturing process or the like. Specifically, the aluminum plating layer 14 may have a chemical composition consisting of, in terms of mass %, for example, 5% to 12% of Si (silicon), and a remainder: aluminum and impurities. The aluminum plating layer 14 may have a chemical composition consisting of, in terms of mass %, 5% to 12% of Si (silicon), 2% to 4% of Fe (iron), and a remainder: aluminum and impurities.

When Si is contained in the aluminum plating layer 14 within the above range, deterioration of workability and corrosion resistance can be suppressed. In addition, the thickness of the intermetallic compound layer can be reduced.

The thickness of the aluminum plating layer 14 in the first plated portion 26 is not particularly limited, but is for example, favorably 8 μm (micrometer) or more, and preferably 15 μm or more in terms of an average thickness. In addition, the thickness of the aluminum plating layer 14 in the first plated portion 26 is, for example, favorably 50 μm or less, preferably 40 μm or less, more preferably 35 μm or less, and still more preferably 30 μm or less in terms of an average thickness.

Note that the thickness of the aluminum plating layer 14 represents an average thickness thereof in the first plated portion 26 of the steel sheet 100.

The aluminum plating layer 14 prevents corrosion of the base steel sheet 12. In addition, when the base steel sheet 12 is processed by hot press forming, the aluminum plating layer 14 prevents generation of scale (iron compound) due to oxidation of a surface of the base steel sheet 12 even when the base steel sheet 12 is heated to a high temperature. In addition, the aluminum plating layer 14 has a boiling point and a melting point higher than those of plating with an organic material and plating with another metallic material (for example, a zinc-based material). Therefore, when a hot press-formed article is formed by hot press forming, coating is not evaporated, and therefore a surface protecting effect is high.

The aluminum plating layer 14 can be alloyed with iron (Fe) in the base steel sheet 12 by heating during hot-dip plating.

### Intermetallic Compound Layer

The intermetallic compound layer 16 is a layer formed at a boundary between the base steel sheet 12 and the aluminum plating layer 14 when aluminum plating is formed on the base steel sheet 12. Specifically, the intermetallic compound layer 16 is formed by a reaction between iron (Fe) of the base steel sheet 12 and a metal containing aluminum (Al) in a molten metal bath mainly containing aluminum. The intermetallic compound layer 16 is mainly formed of a plurality of compounds represented by FeₓAl_{y} (x and y each represent 1 or more). When the aluminum plating layer contains Si (silicon), the intermetallic compound layer 16 is formed of a plurality of compounds represented by FeₓAl_{y} and FeₓAl_{y}Si_{z} (x, y, and z each represent 1 or more).

The thickness of the intermetallic compound layer 16 in the first plated portion 26 is not particularly limited, but is for example, favorably 1 μm or more, preferably 3 μm or more, and more preferably 4 μm or more in terms of an average thickness. In addition, the thickness of the intermetallic compound layer 16 in the first plated portion 26 is, for example, favorably 10 μm or less, and preferably 8 μm or less in terms of an average thickness. Note that the thickness of the intermetallic compound layer 16 represents an average thickness thereof in the first plated portion 26.

Note that the thickness of the intermetallic compound layer 16 can be controlled by a temperature of the molten metal bath mainly containing aluminum and an immersion time.

Here, confirmation of the base steel sheet 12, the intermetallic compound layer 16, and the aluminum plating layer 14, and measurement of the thicknesses of the intermetallic compound layer 16 and the aluminum plating layer 14 are performed by the following methods.

The steel sheet 100 is cut such that a cross section of the steel sheet 100 is exposed, and the cross section of the steel sheet 100 is polished. Note that a direction of the exposed cross section of the steel sheet 100 is not particularly limited. However, the cross section of the steel sheet 100 is preferably a cross section orthogonal to a longitudinal direction of the exposed portion 22.

The polished cross section of the steel sheet 100 from a surface of the steel sheet 100 to the base steel sheet 12 is linearly analyzed with an electron probe microanalyzer (FE-EPMA), and a concentration of aluminum and a concentration of iron are measured. Each of the concentration of aluminum and the concentration of iron is preferably an average value of three measurement values.

Measurement conditions are an acceleration voltage of 15 kV, a beam diameter of about 100 nm, an irradiation time per point of 1000 ms, and a measurement pitch of 60 nm. A measurement distance only needs to be set such that the thickness of the plated layer can be measured, and for example, the measurement distance is about 30 μm to 80 μm in a thickness direction from a surface of the steel sheet 100 to the base steel sheet 12. The thickness of the base steel sheet 12 is preferably measured using a scale with an optical microscope.

### Specifying Ranges of Base Steel Sheet, Intermetallic Compound Layer, and Aluminum Plating Layer

As a measurement value of the concentration of aluminum of a cross section of the steel sheet 100 (plated steel sheet), a region where the aluminum (Al) concentration is less than 0.06 mass % is determined as the base steel sheet 12, and a region where the concentration of aluminum is 0.06 mass % or more is determined as the intermetallic compound layer 16 or the aluminum plating layer 14. In addition, in the intermetallic compound layer 16 and the aluminum plating layer 14, a region where the concentration of iron (Fe) is more than 4 mass % is determined as the intermetallic compound layer 16, and a region where the concentration of iron is 4 mass % or less is determined as the aluminum plating layer 14.

Note that a distance from a boundary between the base steel sheet 12 and the intermetallic compound layer 16 to a boundary between the intermetallic compound layer 16 and the aluminum plating layer 14 is defined as the thickness of the intermetallic compound layer 16. In addition, a distance from the boundary between the intermetallic compound layer 16 and the aluminum plating layer 14 to a surface of the aluminum plating layer 14 is defined as the thickness of the aluminum plating layer 14.

The thickness of the aluminum plating layer 14 and the thickness of the intermetallic compound layer 16 are measured as follows by linearly analyzing a portion from a surface of the steel sheet 100 to a surface of the base steel sheet 12 (boundary between the base steel sheet 12 and the intermetallic compound layer 16).

For example, when the thickness of the first plated portion 26 is measured, in a longitudinal direction of the exposed portion 22 (for example, defined as an X direction in FIG. 1, referred to as a third direction hereinafter), the thicknesses of the aluminum plating layer 14 at five positions obtained by dividing the total length of the first plated portion 26 in the third direction (the same applies to the following definition of the total length) into six equal parts are obtained, and an average value of the obtained values is defined as the thickness of the aluminum plating layer 14. Here, the measurement of the thickness in the first direction is performed at a position of ½ of the width of the first plated portion 26 in each of the five positions in a cross-sectional view (Hereinafter, the thickness is measured similarly.). Note that the width of the first plated portion 26 refers to a distance between end edges of the first plated portion 26 in the first direction F1, and is hereinafter also simply referred to as the width of the first plated portion 26. Distinction among the aluminum plating layer 14, the intermetallic compound layer 16, and the base steel sheet 12 at the time of thickness measurement is determined in accordance with the above-described determination criteria. Note that when the exposed portion 22 extends on a curve, the thickness may be obtained at positions obtained by dividing the total length along the curve into six equal parts.

Similarly, when the thickness of the intermetallic compound layer 16 is measured, the thicknesses of the intermetallic compound layer 16 at five positions obtained by dividing the total length of the intermetallic compound layer 16 in the third direction (the same applies to the following definition of the total length) into six equal parts are obtained, and an average value of the obtained values is defined as the thickness of the intermetallic compound layer 16. The thickness of the intermetallic compound layer 16 of the first plated portion 26 is measured at a position of ½ of the width of the first plated portion 26 as in a case of measuring the thickness of the aluminum plating layer 14. Distinction among the aluminum plating layer 14, the intermetallic compound layer 16, and the base steel sheet 12 at the time of thickness measurement is determined in accordance with the above-described determination criteria.

### Exposed Portion

As illustrated in FIG. 7, the steel sheet 100 has the exposed portion 22 on each of surfaces of the end portion in the removal region 170. On a surface on which the second plated portion 24 is disposed, the exposed portion 22 is disposed between the first plated portion 26 and the second plated portion 24 in the end portion of the removal region 170. On a surface on which the second plated portion 24 is not disposed, the exposed portion 22 is disposed between the first plated portion 26 and the end edge 100A of the steel sheet 100 in the end portion of the removal region 170.

Here, with reference to FIG. 7, when the second plated portion 24 is formed, the exposed portion 22 is formed in a range from the end edge 100C on a boundary between the second plated portion 24 and the exposed portion 22 to the end edge 100B of the first plated portion 26. When the second plated portion 24 is not formed, the exposed portion 22 is formed in a range from the end edge 100A of the steel sheet 100 to the end edge 100B of the first plated portion 26.

The width of the exposed portion 22 in the first direction F1 (distance from the second plated portion 24 to the first plated portion 26 in the first direction F1, hereinafter, also simply referred to as the width of the exposed portion 22) is, for example, favorably 0.1 mm or more on average. By setting the width of the exposed portion 22 to 0.1 mm or more, aluminum can be prevented from remaining in an end portion of a weld during welding of the tailored blank. The width of the exposed portion 22 is favorably 5.0 mm or less on average. By setting the width of the exposed portion 22 to 5.0 mm or less, deterioration of corrosion resistance after coating can be suppressed. When the butt welding is laser welding, the width of the exposed portion 22 is preferably 0.5 mm or more, and is preferably 1.5 mm or less. When the butt welding is plasma welding, the width of the exposed portion 22 is preferably 1.0 mm or more, and is preferably 4.0 mm or less. That is, the width of the exposed portion 22 is preferably 0.1 mm or more and 5.0 mm or less (average). The width of the exposed portion 22 is, for example, a value obtained by measuring the widths of the exposed portion 22 at five cross sections obtained by dividing the total length of the exposed portion 22 in the third direction (X direction) into six equal parts using a scale with a microscope, and averaging the widths (Hereinafter, a method for measuring a width is the same.).

### Second Plated Portion

Similarly to the exposed portion 22, the second plated portion 24 is formed in an end portion of the removal region where the exposed portion 22 is disposed. The second plated portion 24 is preferably disposed on at least one surface of the end portion located around the steel sheet 100 in a region closer to the end edge of the steel sheet 100 than the exposed portion 22 and including the end edge 100A of the steel sheet 100. That is, the second plated portion 24 is preferably disposed along the end edge 100A of the steel sheet 100 in the end portion of the removal region.

The second plated portion 24 is preferably formed in a region including an end edge of the steel sheet 100 so as to be included in a weld after butt welding. The second plated portion 24 is disposed on at least one surface of the end portion of the steel sheet 100 along the end edge of the steel sheet 100 so as to achieve this state.

In the first direction F1, (the whole of) the second plated portion 24 is favorably present in a range within 0.9 mm from the end edge 100A of the steel sheet 100. When the second plated portion 24 is present in this range, the second plated portion 24 is easily contained in the weld after butt welding. By setting a region where the second plated portion 24 is present within this range, at least a region exceeding 0.9 mm from the end edge 100A of the steel sheet 100 toward the first plated portion side is the exposed portion 22. As a result, at least a region on a surface between a weld metal and a heat affected zone after butt welding can be a region where a hard intermetallic compound is not generated. As described above, by defining the width of the second plated portion 24 and the position of the exposed portion 22, it is possible to supply Al necessary for improving corrosion resistance after coating of the weld metal to the weld metal, and to prevent generation of an intermetallic compound that reduces fatigue strength at a boundary between the weld metal and the heat affected zone. The second plated portion 24 is preferably present in a range within 0.5 mm from the end edge 100A of the steel sheet 100, more preferably present in a range within 0.4 mm from the end edge 100A of the steel sheet 100, and still more preferably present in a range within 0.3 mm from the end edge 100A of the steel sheet 100.

For example, the width of the second plated portion 24 is preferably set according to the width of the weld 150 in the tailored blank after butt welding. The width of the weld 150 is, for example, 0.4 mm to 6 mm. When the width of the weld 150 is 0.4 mm, the width of the second plated portion 24 is preferably 0.04 mm or more and less than 0.2 mm, and the sum of the width of the second plated portion 24 and the width of the exposed portion 22 is preferably 0.5 mm or more. When the width of the weld 150 is 1 mm, the width of the second plated portion 24 is preferably 0.3 mm or less, and the sum of the width of the second plated portion 24 and the width of the exposed portion 22 is preferably 0.8 mm or more. When the width of the weld is 2 mm, the width of the second plated portion 24 is preferably 0.8 mm or less, and the sum of the width of the second plated portion 24 and the width of the exposed portion 22 is preferably 1.3 mm or more. When the width of the weld 150 is 6 mm, the width of the second plated portion 24 is preferably 0.9 mm or less, and the sum of the width of the second plated portion 24 and the width of the exposed portion 22 is preferably 3.3 mm or more. The width of the weld 150 changes according to a welding method. Therefore, when the butt welding is laser welding, the width of the second plated portion 24 is preferably 0.05 mm or more, and is preferably 0.40 mm or less. When the butt welding is plasma welding, the width of the second plated portion 24 is preferably 0.10 mm or more, and is preferably 0.60 mm or less.

Here, the width of the exposed portion 22 is an average value of measured widths of the exposed portion 22 at five points, and the width of the second plated portion 24 is an average value of measured widths of the second plated portion 24 at five points. The measurement positions of each of the exposed portion 22 and the second plated portion 24 are five positions obtained by dividing the total length of the exposed portion 22 in the X direction into six equal parts in a longitudinal direction of the exposed portion 22.

A method for measuring the width of the exposed portion 22 and the width of the second plated portion 24 is as follows.

Five measurement samples each including a cross section (for example, a cross section of the steel sheet 100 cut along the first direction F1 in plane view) in which the entire width of each of the exposed portion 22 and the second plated portion 24 formed in the end portion of the steel sheet 100 can be observed are collected. The measurement sample is collected from five positions obtained by dividing the length of the exposed portion 22 formed in a direction along the end edge 100A of the steel sheet 100 into six equal parts. Next, the steel sheet 100 is cut such that a cross section of the steel sheet 100 is exposed. Thereafter, the cut measurement sample is embedded in a resin, polished, and the cross section is enlarged with a microscope. Then, for one sample, the width of the exposed portion 22, which is a distance from the second plated portion 24 to the first plated portion 26, is measured. For each sample, a distance between both end edges of the second plated portion 24 is measured. In a case of FIG. 7, the width w1 of the removal region is the sum of the width of the second plated portion 24 and the width of the exposed portion 22.

### Steel Sheet Manufacturing Method

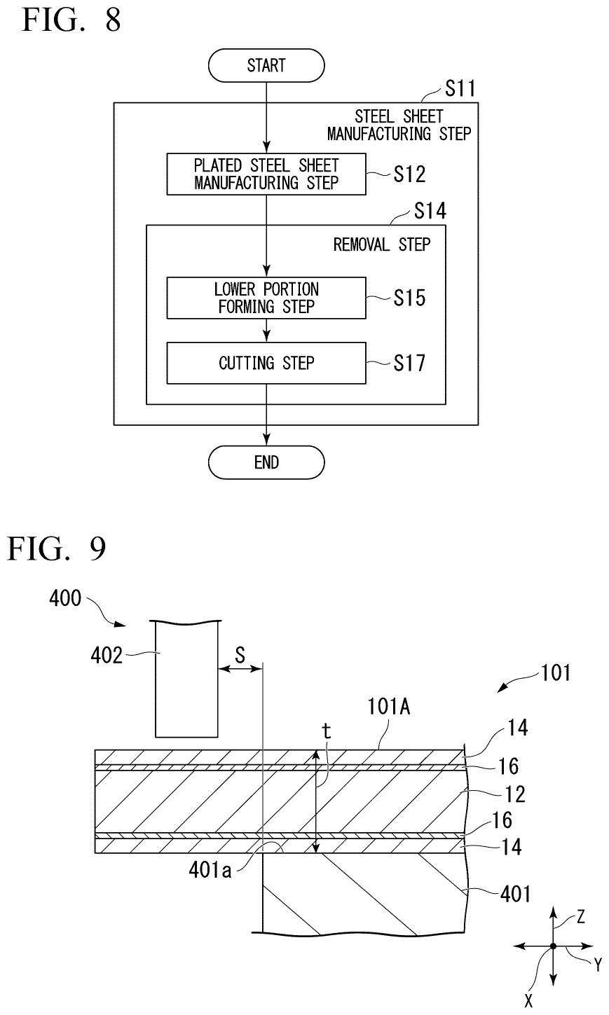

Next, an example of the steel sheet manufacturing method of the present disclosure will be described. A steel sheet to be manufactured is a steel sheet used for manufacturing a structural member designed by the above design method. FIG. 8 is a flowchart indicating a tailored blank manufacturing method S11 of the present disclosure.

First, in the steel sheet (steel sheet for butt welding) manufacturing method S11, a plated steel sheet manufacturing step S12 is performed. In the plated steel sheet manufacturing step S12, a plated steel sheet 101 illustrated in FIG. 9 is manufactured. In the plated steel sheet manufacturing step S12, the plated steel sheet 101 in which the intermetallic compound layer 16 and the aluminum plating layer 14 are disposed in this order from the base steel sheet 12 side is manufactured on each surface of the base steel sheet 12 by a known method. In the plated steel sheet 101, the exposed portion 22 and the second plated portion 24 are not formed on the steel sheet 100 described above.

Here, the thickness of the plated steel sheet 101 is represented by t μm. Note that the thickness of the plated steel sheet 101 is equal to the thickness of the steel sheet 100 in the first plated portion 26.

Upon completion of the plated steel sheet manufacturing step S12, the process proceeds to a removal step S14 as a step S14. Note that the removal step S14 is a step of mechanically removing the aluminum plating layer 14 and the intermetallic compound layer 16. In the removal step S14, a part of the aluminum plating layer 14 and the intermetallic compound layer 16 may be removed such that the first plated portion 26, the exposed portion 22, the second plated portion 24, and the end edge 100C of the plated steel sheet 101 are disposed in this order on one surface of the base steel sheet 12 in the first direction F1 perpendicular to the thickness direction of the plated steel sheet 101 and directed from a center portion of the plated steel sheet 101 to one end edge of the plated steel sheet 101 in plane view, and such that at least the first plated portion 26, the exposed portion 22, and the end edge 100C of the plated steel sheet are disposed in this order on the other surface of the base steel sheet 12 in the first direction F1.

Next, in the removal step S14, a lower portion forming step S15 is performed.

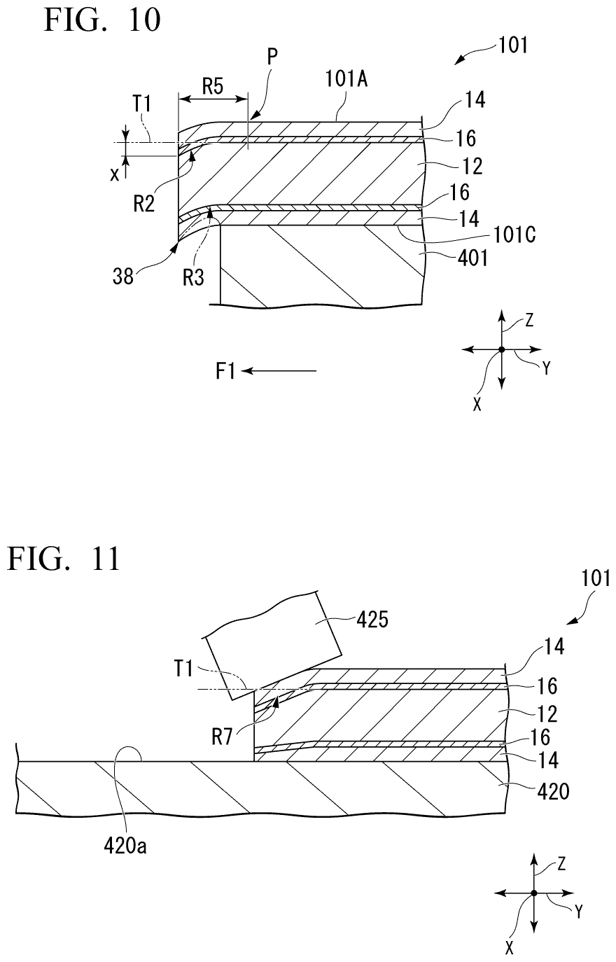

In the lower portion forming step S15, as illustrated in FIG. 10, the plated steel sheet 101 is cut, a part of the plated steel sheet 101 is deformed, and a lower region R2 is formed on a surface of the base steel sheet 12 of the plated steel sheet 101. The lower region R2 is formed at an end edge of the base steel sheet 12. When the plated steel sheet 101 is cut, the plated steel sheet 101 may be cut so as to have the shape of the structural member 10.

Here, the first direction F1 is defined. The first direction F1 is a direction perpendicular to the thickness direction of the plated steel sheet 101 and directed from a center portion of the plated steel sheet 101 to one end edge of the plated steel sheet 101 in plane view. The first direction F1 coincides with the first direction F1 of the steel sheet 100 when the plated steel sheet 101 is processed into the steel sheet 100. The lower region R2 referred to herein means a region of the aluminum plating layer 14 and the intermetallic compound layer 16 located on an inner side of the base steel sheet 12 in the thickness direction with respect to a virtual plane T1 obtained by extending a surface of a portion (for example, the exposed portion 22) of the base steel sheet 12 which is not deformed at the time of cutting in the first direction F1. Note that the virtual plane T1 is an imaginary line when viewed in a cross section perpendicular to the thickness direction.

In this example, in the lower portion forming step S15, the plated steel sheet 101 is cut by shearing (shearing working) which is a mechanical method, and the lower region R2 is formed in the plated steel sheet 101. Note that the lower region R2 may be formed in the plated steel sheet 101 using blanking instead of the shearing. The mechanical method referred to herein means a method in which a tool is brought into direct contact with the plated steel sheet 101, and the plated steel sheet 101 is processed with the tool brought into contact with the plated steel sheet 101.

In the lower portion forming step S15, specifically, as illustrated in FIG. 9, the plated steel sheet 101 is placed on an upper surface 401a of a support base 401 of a shearing device 400. The upper surface 401a is flat and disposed along a horizontal plane. At this time, the upper surface 401a is disposed such that an end portion of the plated steel sheet 101 protrudes from the support base 401.

A blade portion 402 of the shearing device 400 is disposed above the upper surface 401a of the support base 401 with a constant interval S from the support base 401 along the upper surface 401a.

When the blade portion 402 is moved downward and the plated steel sheet 101 is cut in the thickness direction of the plated steel sheet 101 as illustrated in FIG. 10, the end portion of the plated steel sheet 101 is cut. At this time, the lower region R2, which is shear droop, is formed on a first surface 101A of the plated steel sheet 101. A protrusion portion 38, which is burr, is formed on a lower surface of plated steel sheet 101.

Here, the deepest lower portion depth of the lower region R2 is represented by x (μm). The lower portion depth x indicates (an absolute maximum value of) a distance from the virtual plane T1 to a surface of the base steel sheet 12 in the lower region R2. Note that the lower portion depth x can be measured with a known laser profile meter or the like.

By adjusting a material, an interval S, and the like of the plated steel sheet 101, simultaneously with formation of the protrusion portion 38, a lower surface of the plated steel sheet 101 may be deformed as indicated by a two-dot chain line in FIG. 10 to form a lower region R3. Note that the two-dot chain line represents the shape of the lower surface of the plated steel sheet 101.

In this case, in the lower portion forming step S15, the lower region R2 is formed on the upper surface of plated steel sheet 101, and the lower region R3 is formed on the lower surface of plated steel sheet 101. For example, it is considered that the lower region R3 is formed by a material forming the plated steel sheet 101 being drawn toward the protrusion portion 38 due to rigidity of the plated steel sheet 101 when the protrusion portion 38 is formed.

Upon completion of the lower portion forming step S15, the process proceeds to a step S17.

Next, in the cutting step (elimination step) S17, a part of the base steel sheet 12 and the intermetallic compound layer 16 in the removal region 170 of the plated steel sheet 101 is cut by cutting which is a mechanical method to form the exposed portion 22 and the second plated portion 24, thereby manufacturing the steel sheet 100. In the present disclosure, an end mill is used for cutting, and at least the aluminum plating layer 14 and the intermetallic compound layer 16 present outside the plated steel sheet 101 in the thickness direction with respect to the virtual plane T1 and present in the removal region 170 are cut with the end mill to be removed. The plated steel sheet 101 is cut by bringing a blade of the end mill rotating about an axis into direct contact with the plated steel sheet 101.

In addition to the end mill, for example, a cutting tool, an end mill, or a metal saw is used for the cutting S17. Note that, in the elimination step, the aluminum plating layer 14 and the intermetallic compound layer 16 may be ground to be removed. Grindstone, a grinder, or the like is used for grinding.

In the cutting step S17, a region R5 from an end edge of the plated steel sheet 101 to an exceeding position P exceeding the lower region R2 in a direction opposite to the first direction F1 is cut. The exceeding position P is a position to be the end edge 100B of the first plated portion 26 in a later step, and a range between the lower region R2 and the exceeding position P is the exposed portion 22. At this time, a depth at which the region R5 of the plated steel sheet 101 is cut is constant. As a result, manufacturing cost required for cutting can be suppressed. Note that the aluminum plating layer 14 and the intermetallic compound layer 16 on the lower region R2 in the region R5 do not need to be cut.

A depth at which the plated steel sheet 101 is cut is less than the sum of the thickness a of the aluminum plating layer 14, the thickness b of the intermetallic compound layer 16, and the lower portion depth x. That is, the plated steel sheet 101 is cut such that at least a part of the intermetallic compound layer 16 and the aluminum plating layer 14 located in the lower region R2 remains. The exposed portion 22 and the second plated portion 24 are formed by the cutting, and similarly, the base steel sheet 12 and the intermetallic compound layer 16 in the range of the removal region 170 are removed also from the other surface to form the exposed portion 22, thereby manufacturing the steel sheet 100.

Note that, in the steel sheet manufacturing method of the present disclosure, the exposed portion 22 and the second plated portion 24 may be formed in the removal region 170 as follows.

As illustrated in FIG. 11, the plated steel sheet 101 is placed on an upper surface 420a of a support base 420. A lower region R7 is formed on an upper surface of the plated steel sheet 101 using a mechanical method in which an end portion of the plated steel sheet 101 is pressed in the thickness direction of the plated steel sheet 101 with a pressing member 425 such as a pressure roll. The lower region R7 is formed at an end edge of the plated steel sheet 101. Note that a direction of pressing with the pressing member 425 may be inclined with respect to the thickness direction.

In the lower region R7, the deepest recessed portion is located at an end edge of the plated steel sheet 101.

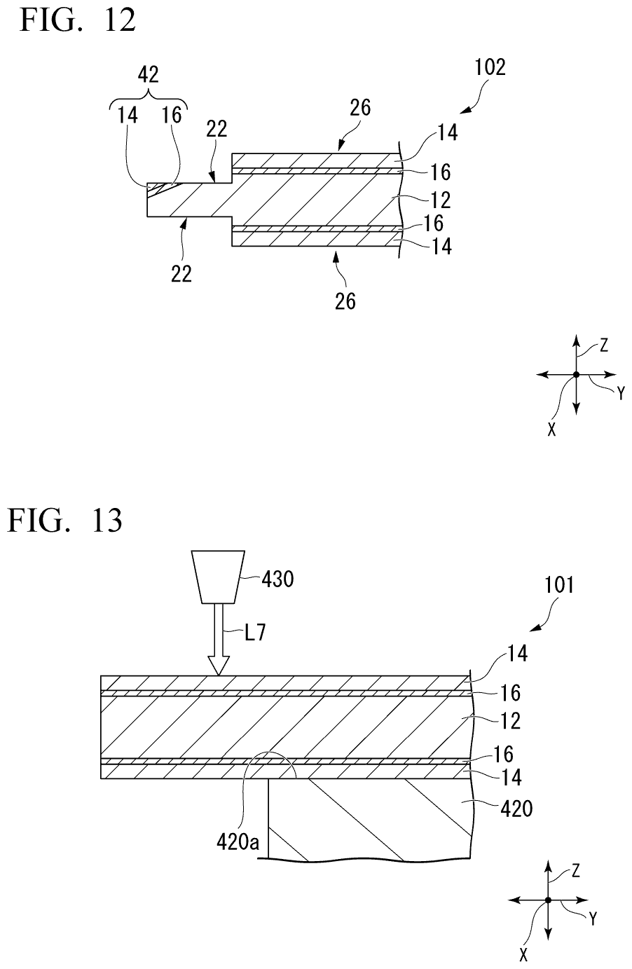

Next, when the cutting step S17 is performed, a steel sheet 102 in which the exposed portion 22 and the second plated portion 42 are formed is manufactured as illustrated in FIG. 12.

In addition, in the manufacturing method of the present disclosure, only the exposed portion 22 may be formed in the removal region 170. That is, in the removal step S14, a part of the aluminum plating layer 14 and the intermetallic compound layer 16 may be removed such that the first plated portion 26, the exposed portion 22, and the end edge 100C of the plated steel sheet are disposed in this order on one surface of the base steel sheet 12 in the first direction F1 perpendicular to the thickness direction of the plated steel sheet 101 and directed from a center portion of the plated steel sheet 101 to one end edge of the plated steel sheet 101 in plane view, and such that at least the first plated portion 26, the exposed portion 22, and the end edge 100C of the plated steel sheet 101 are disposed in this order on the other surface of the base steel sheet 12 in the first direction F1.

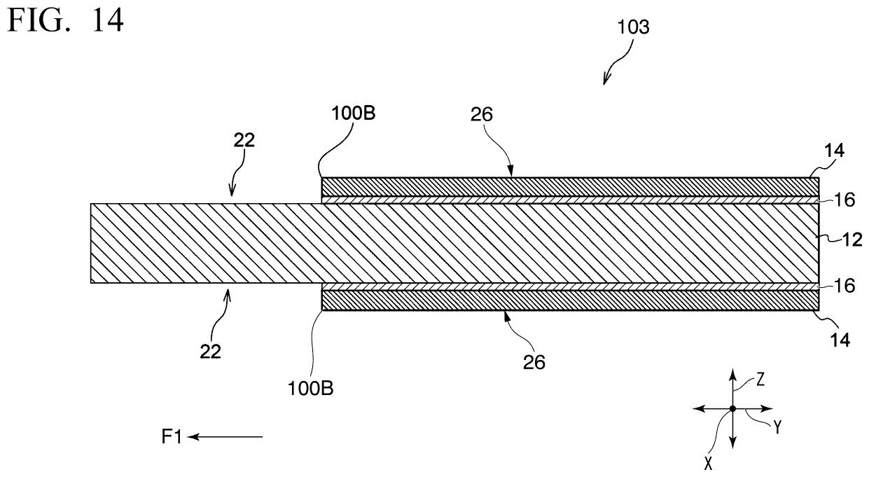

In this example, a laser processing method which is not a mechanical method is used. As illustrated in FIG. 13, an end portion of the plated steel sheet 101 is irradiated with a laser beam L7 from a laser processing apparatus 430 in the thickness direction of plated steel sheet 101. As a result, the end portion of the plated steel sheet 101 is cut, but a lower region is not formed in the plated steel sheet 101. Thereafter, the plated steel sheet 101 is cut using an end mill or the like in a similar manner to that described above to obtain a steel sheet 103 in which only the exposed portion 22 is formed in the removal region 170 as illustrated in FIG. 14.

### Tailored Blank Manufacturing Method

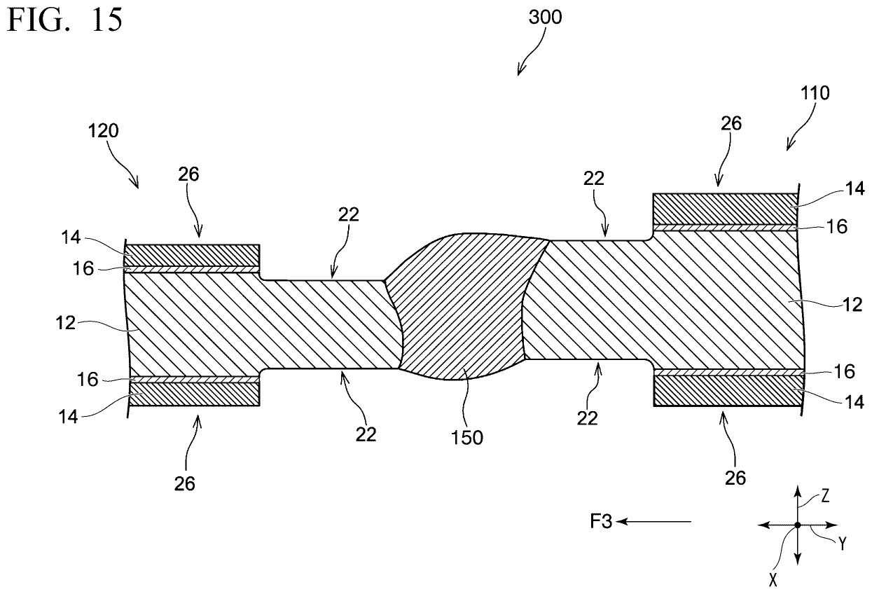

The tailored blank manufacturing method of the present disclosure includes a step of butt-welding the steel sheets of the present disclosure by a known method. Specifically, as illustrated in FIG. 6, end portions of the steel sheets 110 and 120 having exposed portions are disposed in a butt state, and the steel sheets 110 and 120 are butt-welded, for example, using a known laser welding device (not illustrated). As a result, the weld 150 is formed to obtain a tailored blank 300 of FIG. 15. The weld 150 is formed at a position set in the weld setting step S5.

### Structural Member Manufacturing Method

The structural member manufacturing method of the present invention includes a step of hot-stamping the tailored blank 300 manufactured above. By hot stamping, for example, the structural member 10 formed into the structure of FIGS. 1 and 2 can be obtained.

### Structural Member

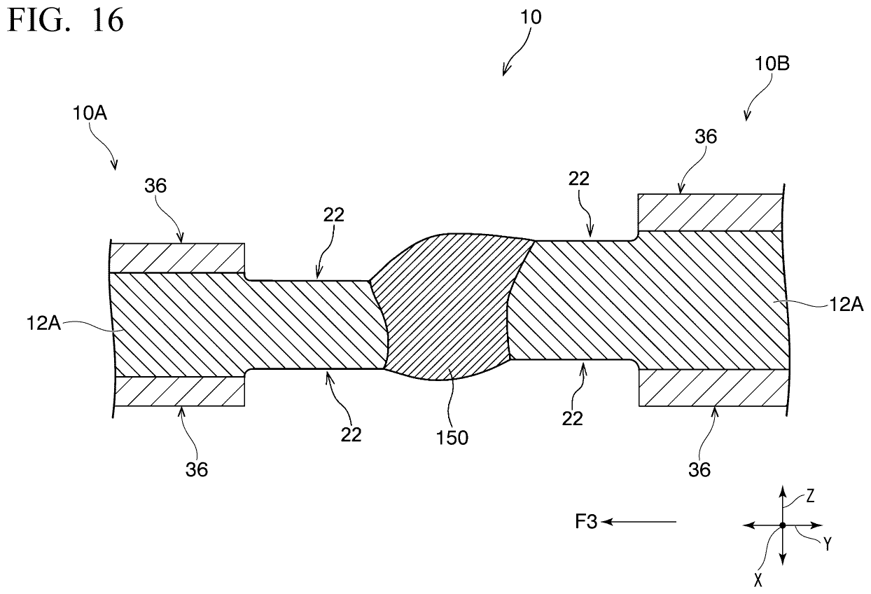

The structural member 10 of the present disclosure will be described. FIG. 16 is a cross-sectional view of the structural member 10 of FIG. 1, taken along line B-B. The structural member 10 of the present disclosure is the structural member 10 in which the linear weld 150 is formed. The structural member 10 includes two or more steel members 10A and 10B joined by the weld 150. The structural member 10 includes the top sheet portion 5, the pair of side wall portions 3 bent and connected from an end portion of the top sheet portion 5, the first ridge portion 2 connecting the top sheet portion 5 and the side wall portions 3, the pair of flange sections 1 bent and connected from end portions of the side wall portions 3, and the second ridge portion 4 connecting the side wall portions 3 and the flange sections 1. The steel members 10A and 10B each include a base metal 12A and a plated layer 36 disposed on a surface of the base metal 12A. In the structural member 10 of the present disclosure, the plated layer 36 is, for example, an intermetallic compound layer. The steel members 10A and 10B include the exposed portions 22 where the base metal 12A is exposed in regions adjacent to each other along the weld 150. The exposed portion 22 is partially present in an extending direction of the weld 150.

The exposed portion 22 is present in a portion corresponding to a fracture assumed portion of the structural member 10. The fracture assumed portion is a portion where a stress is most concentrated in the weld when a load is applied to the structural member 10 under a specific load input condition. As the fracture assumed portion, a portion where a stress is likely to concentrate, such as a flange section, may be empirically determined, or the fracture assumed portion may be a region where a fracture index is equal to or larger than a specified value in crash analysis. Examples of a method for specifying the fracture assumed portion of the structural member 10 by crash analysis include the following methods. For the structural member 10, for example, three-dimensional shape data is acquired using a three-dimensional scanner or from CAD data, and a structure model including a weld is created on the basis of the shape data and mechanical properties of a material. Crash analysis is performed on the obtained structure model under a specific load input condition under a condition that an exposed portion is not formed, and a region having a high fracture index is specified. As the fracture index, strain is preferable. When a mesh size of the structure model increases, even when a large strain locally occurs in a mesh, the strain is dispersed in a region of the mesh. Therefore, an equivalent plastic strain in which fracture occurs tends to decrease as the mesh size increases. A threshold of the equivalent plastic strain at the time of determining the fracture assumed portion can be set to 5 to 20%, for example, in a case of analysis with a mesh size of 1 mm to 4 mm. Specifically, when the mesh size of the structure model is 2 mm, a region where the equivalent plastic strain is 10% or more can be determined as the fracture assumed portion.

The exposed portion 22 is preferably present in a portion other than the side wall portion 3. By presence of the exposed portion 22 in a portion other than the side wall portion 3, a region from which the aluminum plating layer and the intermetallic compound layer are removed can be reduced while the strength of a portion having a high fracture risk is maintained. The exposed portion 22 is preferably present in any one or more of the flange section 1, the first ridge portion 2, the second ridge portion 4, and the top sheet portion 5. The exposed portion 22 is preferably present in the top sheet portion 5, the flange section 1, or the top sheet portion 5 and the flange section 1. The exposed portion 22 is particularly preferably present only in the flange section 1. By presence of the exposed portion 22 only in the flange section 22, fracture of the flange section 1 to which another member is connected can be suppressed, and load bearing performance of the structural member 10 can be improved.

As described above, according to the structural member design method, the steel sheet manufacturing method, the tailored blank manufacturing method, the structural member manufacturing method, and the structural member of the present disclosure, fracture of the structural member can be suppressed, and time for removing aluminum plating can be shortened.

Note that the technical scope of the present invention is not limited only to the above-described embodiment, and various modification can be made without departing from the gist of the present invention. In the above case, the second plated portion is formed by forming the lower region, but the second plated portion may be formed without forming the lower region by partially removing the aluminum plating using a laser.

In plane view of the structural member 10, an angle formed by a longitudinal direction of the structural member 10 and a weld line of the flange section is preferably 80° or less. When the angle formed by the longitudinal direction of the structural member 10 and the weld line of the flange section is 80° or less, the exposed portion 22 does not need to be disposed in the flange section 1.

In addition, it is possible to appropriately replace the constituent elements in the embodiment with well-known constituent elements without departing from the gist of the present invention, and the above-described modification examples may be appropriately combined with each other.

### EXAMPLES

Next, Examples of the present invention will be described, but conditions in Examples are examples of conditions adopted to confirm feasibility and an effect of the present invention, and the present invention is not limited to these examples of conditions. The present invention can adopt various conditions as long as the object of the present invention is achieved without departing from the gist of the present invention.

### Design of Weld

The crash analysis was performed using LS-DYNA (registered trademark), and analysis of a fracture index was performed using NSafe (registered trademark)-MAT. Crash analysis was performed on the shape of the B-pillar in FIG. 1, and the position of the weld was determined such that a fracture index (strain) of the first region was equal to or more than a fracture threshold and a fracture index (strain) of a region other than the first region was less than the fracture threshold in the weld. The crash analysis was performed using a full car model with an IIHS side collision honeycomb barrier as a barrier, a cart weight of 1500 kg, and a collision speed of 50 km/h. A member A had a tensile strength of 2000 MPa and a sheet thickness of 2.2 mm. A member B had a tensile strength of 1300 MPa and a sheet thickness of 1.6 mm.

### Example 1

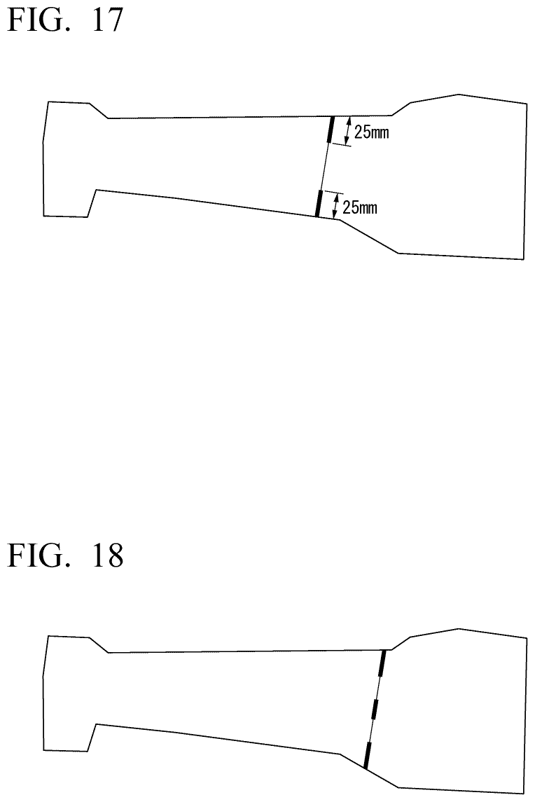

In Example 1, only the flange section was set as the first region. Analysis was performed on two plated steel sheets (aluminum plating layer: 30 μm, intermetallic compound layer: 8 μm) formed as illustrated in FIG. 17 by assuming that the aluminum plating layer and the intermetallic compound layer in a portion to be only the flange section having a high fracture risk were cut with a one-side length of 25 mm (length in total of upper and lower surfaces: 100 mm).

### Example 2

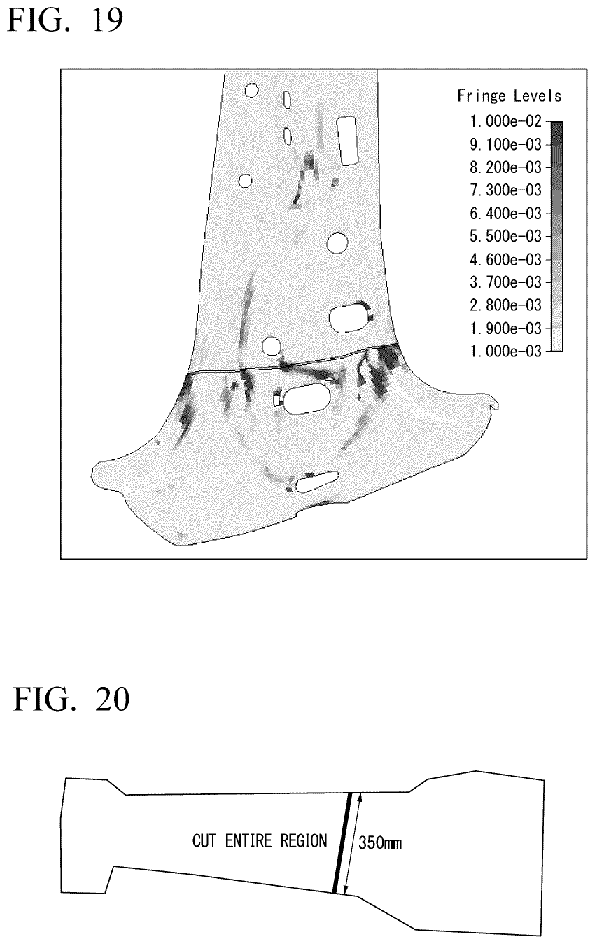

In Example 2, the flange section, the ridge portion, and the top sheet portion were set as the first region. As illustrated in FIG. 18, the weld was determined such that fracture indices of the flange section, the ridge portion, and the top sheet portion were high. Analysis was performed on two plated steel sheets (aluminum plating layer: 30 μm, intermetallic compound layer: 8 μm) formed as illustrated in FIG. 19 by assuming that the aluminum plating layer and the intermetallic compound layer in a portion to be the flange section, the ridge portion, and the top sheet portion having a high fracture risk were cut with a length in total of upper and lower surfaces of 380 mm.

### Comparative Example 1

Analysis was performed on two plated steel sheets (aluminum plating layer: 30 μm, intermetallic compound layer: 8 μm) formed as illustrated in FIG. 20 by assuming that the aluminum plating layer and the intermetallic compound layer in an entire region where the weld was to be formed (length in total of upper and lower surfaces: 700 mm).

### Comparative Example 2

Analysis was performed on two plated steel sheets having the same shapes as those in FIG. 17 by assuming that cutting was not performed.

### Intrusion Amount Analysis

Crash analysis was performed under the conditions of Examples 1 and 2 and Comparative Examples 1 and 2, and evaluation was performed using intrusion amounts at five points having different heights from a vehicle lower end. Analysis at the time of collision was performed by LS-DYNA, and analysis of a fracture index was performed using NSafe-MAT. The crash analysis was performed using a full car model with an IIHS side collision honeycomb barrier as a barrier, a cart weight of 1500 kg, and a collision speed of 50 km/h. The member A had a tensile strength of 2000 MPa and a sheet thickness of 2.2 mm. The member B had a tensile strength of 1300 MPa and a sheet thickness of 1.6 mm.

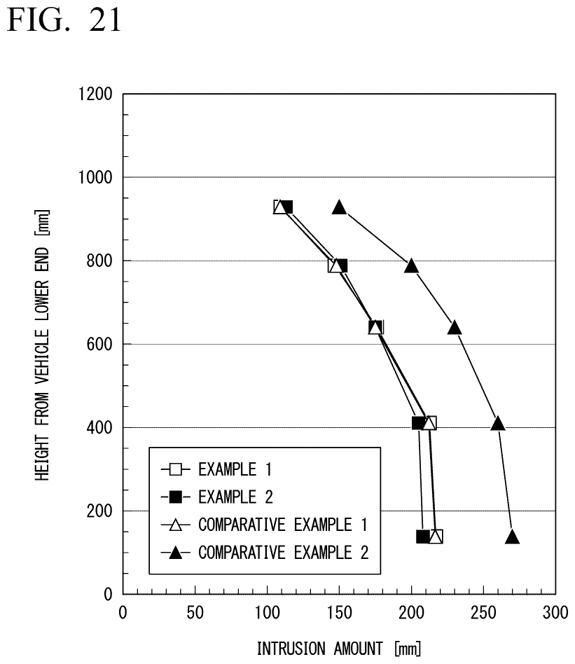

Obtained results are illustrated in FIG. 21. In Examples 1 and 2, similarly to Comparative Example 1 in which the entire region was removed, the structural member was not fractured, and the intrusion amount could be suppressed. On the other hand, in Comparative Example 2 in which cutting was not performed, fracture occurred.

### Working Time and Tool Life

With a scanning speed of 6 m/min, a rotation speed of 40,000 rpm, a tool diameter φ of 6 mm, an end portion R of 0.5 mm, and a tool life of 300 m as a working length, processing time and the tool life were obtained for Examples and Comparative Examples. Obtained results are illustrated in Table 1. “-” in Table 1 indicates that processing is not performed.

TABLE 1

| | | Processing time | Tool life | Fracture |
|---|---|---|---|---|
| | Notes | (second/piece) | (piece) | of TWB |
| Example 1 | Only flange is cut | 1 | 3000 | Not |
| | | | | occurred |
| Example 2 | flange + part of | 3.8 | 789 | Not |
| | top sheet + ridge | | | occurred |
| Comparative | Entire width is | 7 | 428 | Not |
| Example 1 | cut | | | occurred |
| Comparative | No cutting is | 0 | — | Occurred |
| Example 2 | performed | | | |

As illustrated in Table 1, in Example 1, since a processing range was only the flange section, the processing time was short and the tool life was long. In Example 2 in which the flange section, the top sheet portion, and the ridge portion were cut, the tool life was shorter than that in Example 1, but the tool life was longer than that in Comparative Example 1. From the above results, it was confirmed that fracture of the structural member could be suppressed and the time for removing the aluminum plating could be shortened by using the structural member design method of the present disclosure.

### BRIEF DESCRIPTION OF THE REFERENCE SYMBOLS

1 Flange section
2 First ridge portion
3 Side wall portion, second ridge portion
5 Top sheet portion
10 Structural member
12 Base steel sheet
14 Aluminum plating layer
16 Intermetallic compound layer
22 Exposed portion
26 First plated portion
42 Second plated portion

1. A structural member design method, a structural member being obtained by forming a tailored blank,
the tailored blank including a linear weld formed by butt-welding two or more steel sheets, and
the steel sheet before being butt-welded including, on a surface of a base steel sheet, an exposed portion where the base steel sheet is exposed at a part of a joined end portion to be butt-welded of a plated steel sheet in which an intermetallic compound layer and an aluminum plating layer are disposed in this order from the base steel sheet side,
the structural member design method comprising:
a weld setting step of performing crash analysis by numerical simulation on an analytical model of the structural member, and setting a position of the weld such that a fracture index of a first region that is at least a part of the weld in an extending direction of the weld is equal to or more than a specified value, and the fracture indices of all remaining regions other than the first region in the weld are less than the specified value; and
a removal region setting step of setting, after the weld setting step, a region including a portion corresponding to the first region in the joined end portion as a removal region where the exposed portion is formed.

2. The structural member design method according to claim 1, wherein
the structural member includes a flange section to be joined to another member, and
the first region is located in the flange section.

3. A steel sheet manufacturing method used for manufacturing a structural member designed by the structural member design method according to claim 1, the steel sheet manufacturing method comprising:
a step of providing a plated steel sheet in which the intermetallic compound layer and the aluminum plating layer are disposed in this order from the base steel sheet side on a surface of the base steel sheet; and
a removal step of removing a part of the aluminum plating layer and the intermetallic compound layer in the removal region to form an exposed portion where the base steel sheet is exposed, a first plated portion in which the intermetallic compound layer and the aluminum plating layer remain in this order from the base steel sheet side on the surface of the base steel sheet, and a second plated portion in which the intermetallic compound layer and the aluminum plating layer remain on the surface of the base steel sheet, wherein
in the removal step, a part of the aluminum plating layer and the intermetallic compound layer is removed such that the first plated portion, the exposed portion, the second plated portion, and one end edge of the plated steel sheet are disposed in this order on one surface of the base steel sheet in a first direction perpendicular to a thickness direction of the plated steel sheet and directed from a center portion of the plated steel sheet to the end edge of the plated steel sheet in plane view, and such that at least the first plated portion, the exposed portion, and the end edge of the plated steel sheet are disposed in this order on the other surface of the base steel sheet in the first direction.

4. A steel sheet manufacturing method used for manufacturing a structural member designed by the structural member design method according to claim 1, the steel sheet manufacturing method comprising:
a step of providing a plated steel sheet in which the intermetallic compound layer and the aluminum plating layer are disposed in this order from the base steel sheet side on a surface of the base steel sheet; and
a removal step of removing a part of the aluminum plating layer and the intermetallic compound layer in the removal region to form an exposed portion where the base steel sheet is exposed and a first plated portion in which the intermetallic compound layer and the aluminum plating layer remain in this order from the base steel sheet side on the surface of the base steel sheet, wherein
in the removal step, a part of the aluminum plating layer and the intermetallic compound layer is removed such that the first plated portion, the exposed portion, and one end edge of the plated steel sheet are disposed in this order on one surface of the base steel sheet in a first direction perpendicular to a thickness direction of the plated steel sheet and directed from a center portion of the plated steel sheet to the end edge of the plated steel sheet in plane view, and such that at least the first plated portion, the exposed portion, and the end edge of the plated steel sheet are disposed in this order on the other surface of the base steel sheet in the first direction.

5. A tailored blank manufacturing method comprising a step of butt-welding steel sheets manufactured by the steel sheet manufacturing method according to claim 4.

6. A structural member manufacturing method comprising a step of hot-stamping a tailored blank manufactured by the tailored blank manufacturing method according to claim 5.

7. A structural member having a linear weld formed therein,
the structural member comprising two or more steel members joined by the weld, wherein
each of the steel members includes:
a base metal; and
a plated layer disposed on a surface of the base metal,
the steel members include exposed portions where the base metal is exposed in regions adjacent to each other along the weld, and
the exposed portions are partially present in an extending direction of the weld.

8. The structural member according to claim 7, wherein the exposed portion is present in a portion corresponding to a fracture assumed portion in the structural member.

9. The structural member according to claim 7, comprising:
a top sheet portion;
a pair of side wall portions bent and connected from an end portion of the top sheet portion;
a first ridge portion connecting the top sheet portion and the side wall portions;
a pair of flange sections bent and connected from end portions of the side wall portions; and
a second ridge portion connecting the side wall portions and the flange sections, wherein
the exposed portion is present in a portion other than the side wall portions.

10. The structural member according to claim 9, wherein the exposed portion is present only in the flange section.

11. A steel sheet manufacturing method used for manufacturing a structural member designed by the structural member design method according to claim 2, the steel sheet manufacturing method comprising:
a step of providing a plated steel sheet in which the intermetallic compound layer and the aluminum plating layer are disposed in this order from the base steel sheet side on a surface of the base steel sheet; and
a removal step of removing a part of the aluminum plating layer and the intermetallic compound layer in the removal region to form an exposed portion where the base steel sheet is exposed, a first plated portion in which the intermetallic compound layer and the aluminum plating layer remain in this order from the base steel sheet side on the surface of the base steel sheet, and a second plated portion in which the intermetallic compound layer and the aluminum plating layer remain on the surface of the base steel sheet, wherein
in the removal step, a part of the aluminum plating layer and the intermetallic compound layer is removed such that the first plated portion, the exposed portion, the second plated portion, and one end edge of the plated steel sheet are disposed in this order on one surface of the base steel sheet in a first direction perpendicular to a thickness direction of the plated steel sheet and directed from a center portion of the plated steel sheet to the end edge of the plated steel sheet in plane view, and such that at least the first plated portion, the exposed portion, and the end edge of the plated steel sheet are disposed in this order on the other surface of the base steel sheet in the first direction.

12. A steel sheet manufacturing method used for manufacturing a structural member designed by the structural member design method according to claim 2, the steel sheet manufacturing method comprising:
a step of providing a plated steel sheet in which the intermetallic compound layer and the aluminum plating layer are disposed in this order from the base steel sheet side on a surface of the base steel sheet; and
a removal step of removing a part of the aluminum plating layer and the intermetallic compound layer in the removal region to form an exposed portion where the base steel sheet is exposed and a first plated portion in which the intermetallic compound layer and the aluminum plating layer remain in this order from the base steel sheet side on the surface of the base steel sheet, wherein
in the removal step, a part of the aluminum plating layer and the intermetallic compound layer is removed such that the first plated portion, the exposed portion, and one end edge of the plated steel sheet are disposed in this order on one surface of the base steel sheet in a first direction perpendicular to a thickness direction of the plated steel sheet and directed from a center portion of the plated steel sheet to the end edge of the plated steel sheet in plane view, and such that at least the first plated portion, the exposed portion, and the end edge of the plated steel sheet are disposed in this order on the other surface of the base steel sheet in the first direction.

13. A tailored blank manufacturing method comprising a step of butt-welding steel sheets manufactured by the steel sheet manufacturing method according to claim 12.

14. A structural member manufacturing method comprising a step of hot-stamping a tailored blank manufactured by the tailored blank manufacturing method according to claim 13.
